(19) United States
(12) Patent Application Publication
(10) Pub. No.: US 2016/0106045 A1
(43) Pub. Date: Apr. 21, 2016

(54) METHOD OF PREVENTING SERIOUS WEATHER DISASTERS

(71) Applicant: Yee Man LIU, Hong Kong (CN)

(72) Inventor: Yee Man LIU, Hong Kong (CN)

(21) Appl. No.: 14/781,025

(22) PCT Filed: Mar. 26, 2014
(86) PCT No.: PCT/CN2014/074146

§ 371 Date: Nov. 27, 2015

(30) Foreign Application Priority Data
Mar. 28, 2013 (CN) 201310105246.0

(51) Int. Cl. A01G 15/00

(52) U.S. Cl. CPC A01G 15/00

(57) ABSTRACT

A method for preventing serious weather disasters includes steps of: (A) finding an area, where cloud layers which are thick are gathered, by a conventional meteorological technology; (B) defining an artificial rain position with a highest density, thickness or temperature in the cloud layers; and (C) setting one or more artificial rain bands with a strip shape at the artificial rain position, and providing artificial rain, in such a manner that clouds to which the artificial rain are provided is cooled to rain; temperatures, densities and measurements of the cloud layers are lowered; and hot air below the cloud layers is released; wherein the clouds after being cooled flow to and cool hot clouds nearby, so as to rain one after another, thus eliminating natural conditions for forming the serious weather disasters.

### CROSS REFERENCE OF RELATED APPLICATION

This is a U.S. National Stage under 35 U.S.C 371 of the International Application PCT/CN2014/074146, filed Mar. 26, 2014, which claims priority under 35 U.S.C. 119(a-d) to CN 201310105246.0, filed Mar. 28, 2013.

### BACKGROUND OF THE PRESENT INVENTION

1. Field of Invention

The present invention relates to a field of preventing natural disasters, and more particularly to a method for preventing serious weather disasters.

2. Description of Related Arts

In recent years, severe weather disasters, which happen once every hundred years or even unprecedented, often occur to the Earth, such as exceptionally strong typhoons, tornadoes, floods, lightning, hail, high temperature, drought, cold, snow, fog, serious urban air pollution. Furthermore, the above natural disasters will be increasingly serious due to global warming. For example, in 2013, there are total 30 typhoons in Asia, which are increased by six compared with 2012, and the super typhoon <Swallow> was actually an unprecedented super typhoon of Novembers.

Some argue that the tornadoes and typhoons are generated by the Moon or Earth gravity, but six more typhoons in a year prove the theory wrong. Some theories also mistakenly believe that desert dust devil is of the same kind of tornado (causes of the dust devil will be described in detail below. Because people had not found that the formation of the above natural disasters are related to “natural strong sensing capability” which is described below, causes thereof were not able to be explained.

Modern meteorological staff has been able to carry out accurate prediction of part of the above natural disasters, and even able to effectively predict the rate of tornado within a wide area, a short moving distance of typhoon, strength, etc., and then notifies the residents of the affected areas in advance for preparedness measures or early evacuation. However, the formation of the above natural disasters is unstoppable. People eagerly look forward to change the current situation of passive prevention and find a method to prevent the formation of the above natural disasters in advance.

The following two events are able to prove no conventional theory is yet able to explain a process of cloud gathering for forming extremely high density, and some extreme weathers unknown to weather experts are related to increase of cloud as well as geographical location.

(A) Years ago, between spring and summer, when the inventor had a travel in <Hainan>, a tour guide illustrated the reason why a cloud layer [like a white hat] often individually occurs above an independent, oblique, pyramid-type and high mountain, so that visitors surprised. In some areas of the world, mountains with above situations are called God Mountains. The guide used explanation from some experts, and said that the mountain comprises a lot of minerals sucking the cloud, which is of course illogical.

(B) In 2007, two senior meteorological officials of Hong Kong publicly said that Hong Kong would generally get no winter. However, since 2008, every winter in Hong Kong suffered extremely cold weather, which proves the meteorological officials or conventional meteorological theory has not realized low temperature will be caused after cloud is gathered by global warming, but rather believes global warming will only increase the temperature of Earth. Furthermore, it is not considered that special geographical positions, sun positions and in particular cloud increase, etc., are all weather-related.

Strong monsoon [intense cold flow or strong sandstorm] occurs during Asian winter because dense cloud layer in the north or north-west of the Asian continent blocks the sun and freezing the ground. The sudden cold ground air will be strongly sucked by eastern or southern ocean warm for forming strong cold flow or strong monsoon. Cloud increase of the Earth will inevitably increase the strong cold flow or sand storm.

Global warming will evaporate more clouds, and the cloud absorbs heat, storages heat, is more constant than air in temperature, and is self-movable. Also, the cloud is substance which forms active low atmospheric pressure and the low atmospheric pressure will suck periphery clouds, so as to gather clouds in an area of the low atmospheric pressure, which certainly causes few or no cloud areas, thereby forming strong active high atmospheric pressure. Therefore, increase of Earth cloud and heat will gather clouds for being larger and denser, thus forming lower atmospheric pressure.

For example, in January 2014, a district of the United States which is nearly a thousand kilometers away from the Arctic Circle suffered a snow disaster with a temperature of −50° C. The temperature is 20° C. lower than the northern neighbor country which is closer to the Arctic lower. Such situation proves the accidental low temperature of the district was caused by movable thick cloud layer blocking the sun. During the same period, a country in the southern hemisphere suffered a sudden high temperature of 50° C., which is also caused by the global warming and being within a strong active high atmospheric pressure area without cloud. In winter, cold clouds fall and thick fog appears.

Conventionally, air pollution and thick fog are also major global problems, especially in China whose artificial heat is significant increased compared with a few decades ago. The inventor also deeply studied serious air pollution, and think serious air pollution is also related to global warming, cloud increase, artificial heat (thermal pollution) and great increase of exhaust. For example, after burning a large number of petrochemical materials, a lot of hot gas rises and heats atmosphere and cloud layers, and the cloud layer with high temperature is difficult to be cooled into rain, so as to be piled up, which forms strong active low atmospheric pressure and inhales polluted air.

Dense cloud layer will block normal rising polluted air, which causes thick PM2.5 and extremely low visibility. In fact, in areas with frequently serious air pollution, when pressure is high and thus no cloud is formed, visibility is high and the air is fresh, proving that serious air pollution is related to weather or atmospheric pressure.

Big cities or high industrial density provinces, especially low-altitude cities or provinces have higher temperatures, which will form a so-called “heat island effect”. The hot island effect keeps the hot air (including hot exhaust gas) within the big cities or provinces without diffusion, and the hot air absorbing surrounding exhaust gas. “Heat island effect” also sucks a lot of cloud and remains in the heat island, wherein prolonged cloudy will drop atmospheric pressure, which accelerates absorbing surrounding clouds and polluted air. True reasons of atmospheric pressure drop will be detailed below.

### SUMMARY OF THE PRESENT INVENTION

For preventing disasters caused by serious weathers, the present invention provides a method for preventing serious weather disasters. According to the method, a long artificial rain band is set at an artificial rain position, and artificial rain is provided at the artificial rain band before the serious weather disasters are formed. Rain will lower temperatures, densities and measurements of cloud layers; release hot air below the cloud layers, decrease pressure difference between top and bottom of the cloud layers, and lower temperatures below the cloud layers and of a ground.

Theories of the present invention are as follows.

After being exposed to the sun, land, which is less constant in temperature, is more rapidly heated and hotter than sea, which is more constant in temperature. Furthermore, the land absorbs heat and will more strongly reflect the heat upwards. Therefore, during warm seasons, land air is hotter than sea air. Because a mountain is at a tropical island with a low altitude, heat moisture is more. In addition, for higher mountain with greater slope, wet ground surface area having trees and grass is further greater than flat ground surface area. Therefore, more heat and wet air are gathered and rise, which firstly forms a small cloud cluster at the top of the mountain.

Because the small cloud cluster is near a top surface of the mountain and the surface will reflect the heat of sun upwards, the small cloud cluster at the top of the mountain will absorb the heat from the top of the mountain as well as from the sun, in such a manner that a temperature of the small cloud cluster is higher than scattered clouds nearby with same altitude but not above mountain. Therefore, the small cloud cluster with high temperature will suck the scattered clouds nearby for forming a big cloud cluster. According to the present invention, it is recognized as a natural law that the hot cloud or hot air sucks cold cloud or cold air, cloud is also an object which absorbs and storages heat and is more constant in temperature than air. Therefore, the greater the cloud cluster is, the hotter and more constant in temperature the cloud cluster will be.

The hot cloud cluster will not flow out of the mountain top with the higher temperature [unless there are strong winds], and clouds inside the hot cloud cluster will not flow out or scatter (while cold cloud does). Therefore, the hot cloud cluster will stay at the mountain top with the higher temperature, and will continue to intake lower temperature clouds nearby for forming a cloud layer which is larger, denser and thicker. That is why there is always a single and extremely dense cloud layer gathered thereon, until the density is large enough to rain at the top of the mountain.

It is proved above that cloud layers are easy to be gathered above high mountain tops, mountain areas, high temperature cities or sea islands with a temperature higher than a constant temperature of sea water. That is why more rain and extremely heavy rainfall are at the high mountain areas. In fact, in seasons with cold sea and hot land, when getting near Taiwan, any small island, or high mountains by plane, cloud layers are often gathered, while there is few cloud layers above the sea around. Therefore, huge typhoon cloud layers are more likely to be formed above ocean with islands.

It is also proved by the above conditions that if the temperature of a region is artificially increased, for example, low-altitude busy cities or provinces will form “heat island effect”, more clouds are easy to be gathered for forming exceptionally strong thunderstorms. Therefore, more city flooding situations happened in the past few years.

The present invention has found that extreme weathers and severe air pollution are associated with geographical locations and environments. For example, Fujian province of China is conventionally the only province with no air pollution problem, which has no actual theoretical explanation. According to the present invention, detailed reasons are as follows. Due to military and political reasons, Fujian province which is close to Taiwan was late to be fully developed into a high heat province. Additionally, an offshore location and a large green area produce less heat, while heat of periphery provinces is great. It is a natural law that hot air sucks cool air, so a small amount of air pollution generated in Fujian province will be absorbed by the periphery provinces with higher temperature, thereby providing no air pollution. Based on the above explanation, serious city air pollution is also related to “thermal pollution”.

Air is the least constant in temperature. When rapidly gathered dense cloud layer blocks the sun or there is no sun in the morning or evening, ground air will be rapidly cooled. However, ground surface which is more constant in temperature keeps a high temperature, and a temperature difference causes fog or low visibility.

In cold seasons, when regions such as low-altitude outskirts with less emissions and ocean with no pollution are rapidly blocked by the dense cloud layer and thus rapidly lowers air temperature, thick fog often happens, which proves that thickening fog of the Earth is also related to the increasing clouds generated by the global warming.

The present invention provides:

a method for preventing serious weather disasters, comprising steps of:

(A) finding an area, where thick cloud layers are gathered, by a conventional meteorological technology;

(B) defining an artificial rain position with a highest density, thickness or temperature in the cloud layers; and

(C) setting one or more artificial rain bands with a strip shape at the artificial rain position, and providing artificial rain, in such a manner that clouds to which the artificial rain is provided are cooled to rain; temperatures, densities and measurements of the cloud layers are lowered; and hot air below the cloud layers is released; wherein the clouds after being cooled flow to and cool hot clouds nearby, so as to rain one after another, thus eliminating natural conditions for forming the serious weather disasters.

The artificial rain bands are set at a position for rapidly cooling hot cloud layers.

The artificial rain position is set at a center or a hottest position of the cloud layers.

The artificial rain bands are set at two sides of a center of the cloud layers.

The serious weather disasters are typhoons, and a center point of the cloud layers has a diameter of 20-40 km.

The serious weather disasters are tornados or rainstorms, and a hottest position of the cloud layers has a diameter of 10-30 km.

Preferably, a method of providing the artificial rain comprises a step of:

dropping an artificial rain agent at an up-middle portion or a top portion of the artificial rain band of the cloud layers for providing the artificial rain.

Preferably, a method of providing the artificial rain comprises a step of:

above the cloud layers which is 600-1000 m away from a wind eye wall, spraying an artificial rain agent around a wind eye, until the wind eye is artificially expanded by 0.5-4 km.

According to the method for preventing serious weather disasters of the present invention, advantages thereof are as follows:

(a) The area with large thick dense cloud layers gathered is found by the conventional meteorological technology.

(b) According to the novel theory of the present invention, complex processes that the cloud layers are gathered into extremely large and thick layers, and the cloud layers are compassed into extremely dense and hot layers are confirmed.

(c) A most effective artificial rain position is set among the cloud layers.

(d) Most effective strip-shaped artificial rain bands are set at the artificial rain position, and artificial rain is provided before the weather disaster is formed. Rain will lower temperatures, densities and measurements of cloud layers; releases hot air below the cloud layers, decreases pressure difference between top and bottom of the cloud layers, and lowers temperatures below the cloud layers and of a ground. The clouds after being cooled flow to and cool hot clouds nearby, so as to rain one after another and automatically expand an artificial rain area. Therefore, the method for preventing the weather disasters are provided, which avoids personal and property losses.

### BRIEF DESCRIPTION OF THE DRAWINGS

FIG. 1 is a sketch view of an approximately circular typhoon cloud layer according to a preferred embodiment 1 of the present invention.

FIG. 2 is an enlarged view of a center part of the FIG. 1.

FIG. 3 is an enlarged view of a non-center part of the FIG. 1.

FIG. 4 is a sketch view of a long tornado or rainstorm cloud layer according to a preferred embodiment 2 of the present invention.

FIG. 5 is an enlarged view of a hottest part of the FIG. 4.

FIG. 6 is a sketch view of a formed circular typhoon and a wind eye thereof according to a preferred embodiment 3 of the present invention.

FIG. 7 is a partial enlarged view of the FIG. 6.

### DETAILED DESCRIPTION OF THE PREFERRED EMBODIMENT

Referring to the drawings, the present invention is further illustrated.

A problem to be solved by the present invention is to provide a method for preventing serious weather disasters. The weather disasters comprise tornados, typhoons, extremely strong thunderstorms, hails, strong wind shears, localized high temperatures, droughts, and severe air pollution.

Accordingly, the present invention provides: a method for preventing serious weather disasters, comprising steps of:

(A) finding an area, where thick cloud layers are gathered, by a conventional meteorological technology;

(B) defining an artificial rain position with a highest density, thickness or temperature in the cloud layers; and

(C) setting one or more artificial rain bands with a strip shape at the artificial rain position, and providing artificial rain, in such a manner that clouds to which the artificial rain are provided is cooled to rain; temperatures, densities and measurements of the cloud layers are lowered; and hot air below the cloud layers is released; wherein the clouds after being cooled are sucked by hot clouds nearby, so as to cool hot clouds nearby and rain one after another, thus eliminating natural conditions for forming the serious weather disasters.

According to the method, the artificial rain bands are set at a position for rapidly cooling whole cloud layers.

According to the method, the artificial rain position is set at a center or a hottest position of the cloud layers.

According to the method, the artificial rain bands are set at two sides of a center of the cloud layers.

According to the method, the serious weather disasters are typhoons, and a center point of the cloud layers has a diameter of 20-40 km.

According to the method, the serious weather disasters are tornados or rainstorms, and a hottest position of the cloud layers has a diameter of 10-30 km.

According to the method, a method of providing the artificial rain comprises a step of: dropping an artificial rain agent at an up-middle portion or a top portion of the artificial rain band of the cloud layers for providing the artificial rain.

According to the method, a method of providing the artificial rain comprises a step of: above the cloud layers which is 600-1000 m away from a wind eye wall, spraying an artificial rain agent around a wind eye, until the wind eye is artificially expanded by 0.5-4 km.

According to the method for preventing serious weather disasters of the present invention, advantages thereof are as follows:

(a) The area with large thick dense cloud layers gathered is found by the conventional meteorological technology.

(b) According to the novel theory of the present invention, complex processes that the cloud layers are gathered into extremely large and thick layers, and the cloud layers are compassed into extremely dense and hot layers are confirmed.

(c) A most effective artificial rain position is set among the cloud layers.

(d) Most effective strip-shaped artificial rain bands are set at the artificial rain position, and artificial rain is provided before the weather disaster is formed. Rain will lower temperatures, densities and measurements of cloud layers; release hot air below the cloud layers, decrease pressure difference between top and bottom of the cloud layers, and lower temperatures below the cloud layers and of a ground. The clouds after being cooled flow to and cool hot clouds nearby, so as to rain one after another and automatically expand an artificial rain area. Therefore, the method for preventing the weather disasters is provided, which avoids personal and property losses.

Causes of Accelerating Global Warming and Harmfulness Thereof

The present invention recognizes that besides greenhouse gases, the global warming is also caused by increase of Earth clouds and expansion of arid areas as well as deserts, etc., which will be described in detail below.

The Greenhouse gases cause global warming, which will evaporate more clouds. Increase of Earth temperature will certainly make it difficult for the clouds to be cooled into rain, so as to further absorb surrounding clouds and be larger, thicker, denser, more focused and then hotter, which will lead to extreme weathers, including more city air pollution.

It is a natural law that hot cloud sucks cold cloud. A large and hot cloud will surely suck surrounding clouds, which decreases clouds nearby. The more the clouds are, the more focused the clouds will be, which will ultimately centralize the clouds and form a particularly strong thunderstorm causing flooding. Meanwhile, an area with fewer clouds will be hot and dry, resulting in uneven rain areas and less rainfall, which makes an internal part of a mountain lack water.

Mountain is a huge natural “short-period reservoir” above the ground, which provides spring for wetting land below mountain and maintains a lot of rivers. Large amount river water certainly reduces river pollution. In fact, since a few decades ago, constant spring at mountain foot about 100 m high had not been seen again. Furthermore, many lakes dried and desertified or had no water supply, which illustrates that modern rain areas are uneven and rainfall is decreased.

Long-lasting dense cloud layer in one district will lower the atmospheric pressure, and low atmospheric pressure will absorb clouds and polluted air nearby, which reduces visibility. In fact, in recent years, the above situation has greatly reduced visibility in some areas of the Earth (especially in low-altitude areas with large artificial heat and big cities), which will lead to increase of PM2.5 concentration and city flooding. The above problems are able to be simply solved by the artificial rain method of the present invention.

Human has rapidly consumed oil, coal ash and gas, etc., which were originally hidden under ground for millions of years, in a short period of two hundred years, thereby producing a large amount of greenhouse gases, exhaust gases and hot gases. Human also dug out underground metals and cement raw materials. Increase of concrete and metal constructions, which are good at absorbing, storing and reflecting heat, will raise city temperatures. Conventionally, weather experts have yet to pay attention to danger of a lot of rising hot air (i.e. thermal pollution).

Conventionally, Earth annual average temperature is officially used for calculating progress of global warming, because they have not yet understood that clouds are increased after the global warming and then more snows and extreme cold weathers will happen in winters, while so the truth is. For example, in recent years, record-breaking low temperatures have happened in winters, while record-breaking high temperatures have also happened in summers. Since the average temperature balances extremely low temperatures and extremely high temperatures, it is considered that the progress of global warming and dangers thereof are quite mild.

According to the present invention, beside the Earth annual average temperature, a highest temperature and a lowest temperature should also be considered as a standard to calculate a degree of globe warming, because great harm have been done to Earth creatures by the extremely high temperature and the extremely low temperature, especially by drought caused by the extremely high temperature uneven rain area and less rain.

Because global warming base is already high, increase speeds of temperatures and clouds are also high when the sun is shone on warmed surface of the Earth, which likes turning on a heater in a warm room. Therefore, the Earth temperature will inevitably rise faster, and that is why the progress of global warming (a weather worsened progress) is faster than expectation of the experts.

Natural Strong Sensing Capability

Causes of the above natural disasters have not been found, because the natural strong sensing capability, high sensitivity, “micro-dynamics”, etc. are not considered. Therefore, causes and processes of tornadoes, typhoons, sudden localized strong winds, etc. cannot be known.

It is an instinct for the nature to obtain better material or living conditions at all cost. For example, some small animals or insects are able to predict earthquakes; animals in unwell will eat certain foods to autonomy; branches of trees extends to a position most likely to absorb the sun light; aerial roots of <banyan>, which is known as a spiritual tree, are able to naturally grow and form a trunk in a most appropriate position for supporting or pull self weight; and so on.

A pressure difference sensing ability or a temperature difference sensing ability of air or clouds are much higher than that of human beings, and even slight pressure difference or temperature difference is able to be sensed. Therefore, air or cloud will be ready to stay in hottest positions, flow with different speeds, suddenly flow in an opposite direction, or form cloud layer convection [which are reasons for non-directional and transient breeze or blast]. However, it is difficult for human to accurately predict the weather.

Causes of Wind or Cyclone and Wind Flowing by being Sucked

Wind is formed when low-pressure air sucks high-pressure air or hot air sucks cool air. Blowing and sucking are seemingly the same, but in-depth explanations thereof are different and important. For example, when a common dense cloud layer suddenly rains, air below is rapidly cooled. The cold air will be quickly sucked by uncooled air nearby and generates strong gusts.

In winter, cold wind will focus on and continuously pass through a very small crack between a door and a frame [or a brick neck], and thus quickly gets into a room, because the cold wind is sucked by air flow on the other side of the room or hot air inside the room. If the cold wind blows [or pushes] rather instead of being sucked, the cold wind has to be rebounded and spread outside the crack between the door and the frame, and will not continue to quickly enter the room through the crack.

In nature, there are many reasons causing wind. Generally, winds are divided into relatively constant orientation monsoon and shore wind; wide range wind caused by atmospheric pressure difference between high and low atmospheric pressure zones; non-directional local gust or breeze due to local temperature difference; instable strong or weak gust generated inside a active low atmospheric pressure zone; strong wind generated by thunderstorms; strong wind shear; strong winds or tornadoes, typhoons, and so on.

Instable wind is generated inside an active low atmospheric pressure zone because an atmospheric pressure inside the zone is lower than an atmospheric pressure outside the zone, and clouds and air inside the zone are also hot (illustrated below). Therefore, the lower pressure and hot air or clouds inside will strongly suck air or clouds outside, which will generate instable strong wind or breeze inside and outside the zone.

A natural power moves in a form of circle. Rising in a rotating form is easy and moving laterally is easy or flexible, and nature will certainly understand choosing an easy or flexible way. Therefore, sucked high-speed rising air will rotate. For example, eyes of tornadoes and typhoons have suction power; typhoon storm circles, wind eyes, tornados or cyclones all move in a form of circle and rotation; and rapidly rising smoke sucked by a strong kitchen ventilator will rotate.

Some sudden high-speed laterally-moving airflows [or gusts] also rotate. In fact, the “flags” or “wind stumbles” often swerve, which is a result of strong gusts with rotating movement. Rotating flow has higher speed, so localized strong winds, which suddenly appear and are able to blow down trees, are generated. As conventional theories have not been able to determine causes of such wind, it is also called a strange wind by media.

Temperature difference of land with complex environment and topography is large. For example, modern city centers, large iron container yards, large outdoor parking lots, arid sands and so on will rapidly generate heat after sun exposure. Therefore, air at such hot places rapidly rises, and surrounding cool air will be immediately absorbed for filling, which will generate sudden and short-period strong gusts, and such lateral strong gusts rotate with a high speed, thus becomes strong winds or the media called “strange wind.” In fact, containers in the large container yard are often blown to fall by the strange wind. When the hot air is replaced and mixed by the cold air, gusts will stop.

It is a natural law that hot air rises, but when the hot air naturally rises, the hot air is actually sucked upwards. People cannot see rotation when thin air rapidly rises or laterally move, but can see rotation of tornados, rotating dust devil on deserts, and rapidly rising smoke or forest fire due to an extremely high temperature [which is called fire tornado]. However, only being sucked upwards with a high speed is able to be seen.

Low-altitude high-pressure high-temperature high-density heavy air needs to climb to reach a high-altitude low-pressure area, so under normal weather conditions, the low-altitude heavy air only slowly rises. For example, a rising kite relies on lateral wind and an air rising force, and it is the rising force which keeps the kite almost perpendicularly staying for a long time. It is not easy to feel common rising air flows, but tornados will strongly suck ground heavy air upwards.

Because sand is a material which quickly absorbs and reflects heat, a temperature thereof is much higher than an air temperature above the sand when the sand is exposed to the sun, in such a manner that there will be a large temperature difference. If a slightly stronger gust happens in such case (such as strong winds due to rapidly rising hot air), the hot air is likely to quickly rotate and rise, which will generate laterally-move high-speed rotating dust devil. Because the natural power accelerates slowly, the dust devil rotates slowly at a beginning, and then rotates faster and faster.

Due to a low temperature, density and pressure of high-altitude air, the dust devil, which is heavier than air, is not able to rise highly. Therefore, the dust devil is only able to rotate at a low altitude. Accordingly, it is proved that in addition to atmospheric pressure difference, wind is also generated by rising hot air, i.e. pressure difference between sky and ground.

Cloud Characteristics and Bad Effects of Too Many Clouds

The above natural disasters are more frequent in warm seasons, since a main condition thereof is that a lot of hot clouds are gathered in the active low atmospheric pressure zone, and then become extremely dense and hot through cloud convection and cloud internal convection. When cloud characteristics of the cloud and complex gathering process thereof are actually known, it will be easy to prevent the above weather disasters. Therefore, this is necessary for the present invention to explain the cloud characteristics and the gathering process thereof in very detail.

Air contains moisture, particularly during raining, morning or early spring periods. Air above sea surface, lake surface, wetlands and green areas contains more moisture, and thus easy to be gathered to form clouds. After the air rapidly rises to a certain height from hot high-pressure ground [hotter air rises faster and higher], the air is decelerated or stopped due to a low temperature and pressure at a high altitude. After deceleration, the air is easy to be gathered and be dense, and being dense is necessary to reflect light, so the air becomes visible clouds.

The clouds are free to move, which surely appear on the Earth and are evaporated more due to the globe warming. The clouds, which are more constant in temperature than the air, absorb and store heat from the sun and the ground, and are gathered into groups like a property of water. The more the clouds are, the higher the temperature will be, while higher temperature causes more dense groups or layers. The globe warming will certainly make it harder for the cloud layers to be cooled into rain, which will further cause extremely large, thick, dense, concentrated and hot clouds. Therefore, the clouds are easy to produce strong cloud layer convective and become even larger, thicker, denser, hotter and more concentrated, and thus will produce the above serious natural disasters.

In hot sunning days, clouds which are hot due to a low altitude will strongly absorb clouds nearby, which forms a denser and hotter large cloud group in a short time. The large cloud group absorbs and stores more heat, and hotter and denser cloud group is easier to be heated and constant in temperature. Cloud comprising moisture is better at transporting heat than air, especially transporting heat to cooling clouds above the cloud group or layer.

When the sun shines the Earth surface, the surface will absorb and reflect heat, in such a manner that the hot air rises according to the natural law while the hot air is also sucked upwards. Therefore, a temperature of high-altitude air or cloud will be affected by the temperature from the ground. That is to say, the temperature is higher when the air or cloud is closer to the ground; and the temperature is lower when the air or cloud is farther from the ground.

Under blue sky and sun of summer, when a group of dense clouds are directly exposed to the sun, according to the theory that hotter cloud is denser and cloud at a center of a hot cloud group is hotter and thus rises faster, the cloud group is in a shape of column or cauliflower, and an outline or a border thereof is extremely clear. A clear reason is that the hot cloud group strongly absorbs and closely gathers scattered clouds nearby. In fact, on extremely large plain of United States, outlines of some huge super storm cloud layer are also clear. In winter, cold cloud groups or layers are in a loose sheet form.

Since the sea water is more constant in temperature than the land, the land is faster than the sea to be heated or cooled. As a result, during sunny summer daytimes, land air is hotter than sea air, and land cloud layer is also hotter and thus denser, so as to increase heat and density more quickly. In addition, land temperature and air flow are unstable, so thunderstorms or tornados are easy to be generated. At night, small land cloud groups are cooled and spread more quickly which large cloud group or layer is slower. As the ocean air temperature is more constant and the air flow is more stable, the cloud layers above are difficult to be cooled or spread both in day and night, so the temperature-constant ocean is able to gather the cloud layers for a long time. For example, extremely huge typhoon cloud layers are able to be gathered.

In the past, globe warming was slight and clouds were less. When small moving clouds block the fierce sunlight from reaching the ground, a local mobile shadow thereof rapidly cools the ground air at a blocked area. Because the air is not constant in temperature and has a strong ability to sensing temperature, the localized temperature difference of the moving shadow will lead to localized and non-directional breeze, which will form a beautiful scene called “blue sky and sunny”.

In recent years, globe warming has produced more clouds and high temperatures. Therefore, a large number of small hot cloud groups are easy to suck each other and gathered into a large group. That is why modern clouds are mostly large. In fact, in modern times, beautiful blue sky and white cloud in some countries have been greatly reduced due to the global warming, while localized high temperature and drought have been already increased. Since the dense cloud layer is able to block the polluted air from normally rising and lead to low atmospheric pressure, air pollution problems will get worse.

Large cloud layers are able to cover a wide range of the blue sky, and past blue sky and white cloud are less and less. The sky is usually white or gray, which is quite stuffy; or the clouds are strongly absorbed by neighboring cloudy zone (or low atmospheric pressure zone) and form a long-term cloudless weather, which generates deadly heat or drought. In fact, between July and August in 2013, when a plurality of typhoons were formed in sequence on the Western Pacific and rain storms happened at North China one after another, the South China suffered continuous extremely high temperature and drought for 40 days, which proves the clouds of the South China were sucked by the above typhoons and rainstorms.

Typhoon has a huge amount of clouds. In general, globe warming will increase the temperature of the sea water which is temperature-constant [it is proved by continuously chipping sea ices]. However, typhoon is easier to be form with temperature rise of the sea water and increase of the clouds as well as heat. A huge hot cloud layer which is able to form and extremely low pressure will suck a lot of clouds nearby, including a lot of clouds which originally flow to the land. Therefore, by preventing the extremely large cloud layer from continuously absorbing a lot of clouds and expanding to form typhoon, large-range land high temperature and drought around the typhoon area are able to be avoided. In fact, in recent years, there is little rainfall after mainland rainy seasons, because clouds were sucked by high-temperature ocean and formed more stronger typhoons.

It is known that “failure to wind makes 3-day rain”. If typhoon is artificially affected and cannot be formed, the large cloud layers will be sucked by the land and result in heavy rain. However, an already formed typhoon will only focus on a certain area and thus causes serious storms, floods, high tides and big waves.

Larger, thicker and lower cloud groups or layers are hotter, and a temperature thereof may be higher than an air temperature below the cloud groups or layers. Such hot cloud easily sucks the air below and forms tornados. For example, clouds of the Great Plains of United State are quite low from the ground, thereby generating more tornados.

Thunderstorm or tornado cloud layers and typhoon or strong tropical storm cloud layers are formed and gathered at a center of the “active low atmospheric pressure zone”. If the above cloud layers become larger and thicker, clouds at the center will surely be denser, thicker and hotter. The clouds at the center are hottest because of a farthest distance from cool air outside the cloud layers and being surrounded by a huge amount of hot clouds nearby, which is slightly the same as a theory that a central position of a circular large city is hottest.

Because the central position of the cloud layer is hottest, clouds inside the cloud layer will also be strongly absorbed by clouds at the central position with a higher temperature (which is call “cloud internal convection” or “cloud internal compression” according to the present invention), resulting in denser and hotter clouds at the central position. The above process will ultimately lead to an extremely high density and temperature of the entire cloud layer, which enables a tornado or severe thunderstorm cloud layers to be black in no time. Without knowing a truth of the “cloud internal convection”, and processes of compressing the cloud layers into the extremely high density and heating the cloud layers, it is difficult to work out a method for preventing formation of the above weather disasters.

In summers, because of a high temperature of the land and environmental diversity thereof, temperatures of different regions differ from each other, resulting in complex airflows. Therefore, a land large hot cloud layer is mostly long and comprises a few hottest positions, while tornados are only produced at the hottest position. As a result, the land large hot cloud layer is able to generate a plurality of tornados. Airflows above large ocean are simple, so a large hot cloud layer above a tropical ocean is mostly round and comprises one hottest central position. For example, a typhoon has only one wind eye at a central position of cloud layers.

Common “greenhouse gases” without high density are thousands of meters from the ground. However, the density of the cloud layer, which is able to absorb and store heat, is higher than the greenhouse gases, while the cloud layer is only about a few hundred meters from the ground. The cloud layer which is extremely dense and therefore hot is difficult to be cooled into rain, and is almost like a water curtain floating in the air, so as to seriously prevent ground hot air from rising with a normal speed, which causes a temporary “strong greenhouse effect” within a cloud layer area. For example, people will feel very hot or even hard for breathing.

In warm seasons, when a large thick dense hot cloud layer seriously prevents high-pressure hot air of ground or sea surface from normally rising in a short period of time, an air temperature and humidity below the cloud layer will be surely increased. Therefore, a greenhouse effect of the dense cloud layer is far more greatly than a greenhouse of a common greenhouse gas, which reduces city visibility, especially for low-altitude big cities or green areas with large amounts of water vapor rising.

In any season, especially in summers, a strong active low atmospheric pressure will be formed if a large hot cloud layer stays at a certain area for a long time. The strong active low atmospheric pressure will suck surrounding clouds and form an even larger hot cloud layer which is extremely concentrated. Relatively, areas from which the clouds are sucked will be under a high atmospheric pressure due to decrease of clouds, which will produce localized high temperature and drought. For example, high temperature and drought happen on one side while serious flood happens on the other side. In fact, weather conditions in recent years were indeed the case. Causes of the high or low atmospheric pressure will be explained in detail below.

No matter in winters or summers, the temperatures of big cities are will be higher than temperatures of surrounding areas, which is like a heat island. The heat island easily sucks surrounding clouds and the clouds are remained above the heat island [particularly in months with less wind or more clouds], and the clouds will absorb heat from the heat island and prevent the heat and polluted air from normally rising, thereby being hotter. Hotter clouds will absorb more clouds and thus form a thick and dense cloud layer, which forms the “strong greenhouse effect.” The high temperature or the low atmospheric pressure absorbs cool polluted air around the heat island and thus increases PM2.5 concentration and humidity.

The above situation means that high-temperature big cities are easy to be the central position of the cloud layers. Therefore, air pollution and rainfall thereof are greater. In fact, in recent years, major cities, large islands or high mountains with high temperatures are indeed suffered more exceptionally strong thunderstorms which used to happen once a hundred years.

Clouds or cloud layers will only be sucked by a nearest hot zone or low-pressure zone, and will not be sucked by a farther area even with a higher temperature of a lower pressure, because a close distance is able to form strong temperature and pressure differences. The closer the area is, the stronger a suction power will be. As a result, a large and hot cloud layer will suck a neighboring small cloud layer, or the two cloud layers suck each other and form cloud convection.

The large hot dense cloud layer increases an “above-below average temperature” of the land or ocean. The “above-below average temperature” is firstly mentioned by the present invention, a purpose thereof is easy to be expressed. A calculating method thereof comprises steps of: adding an air temperature of a land or ocean with a total average temperature of an entire thousands-meter-thick cloud layer, and then dividing by two [a detailed calculating method is illustrated below].

Based on the above increasing processes of the cloud density and temperature, the hot clouds at the center position and the hot air below the hot clouds will finally reach a heat limit and automatically rise with a high speed, so as to release a rising pressure of the hot clouds and the hot air below the hot clouds, which produces strong thunderstorms, hails, cyclones, strong wind shears, or even tornados. Localized strong wind under the center position of the clouds is similar to a situation that fire site hot air rapidly rises and thus sucks air nearby to fill when an extremely big fire happens somewhere. As a result, the strong wind is generated.

Preventing the cloud layers from being extremely concentrated enables average rain areas and more rainfall, which is able to not only avoid or decrease drought, heat and flood, but also keep river flowing for inhibiting water pollution problems. As a matter of fact, extremely strong floods in recent years were mostly localized and concentrated. For example, some large cities or mountain areas will suffer a one-hundred-millimeter rainfall within a short time.

In the past when globe warming was slight, clouds were less, so temperatures were cooler. As a result, there was no extremely strong cloud convection causing extremely concentrated clouds, which provided more rainfall and average rain areas. The above explanation illustrates hotter Earth will lead to worst weather, less average rainfall, and more uneven rain areas, and so a truth is.

Due to the globe warming, clouds are getting more, hotter and concentrated, and thus has a stronger suction power. Therefore, areas where clouds are sucked are directly exposed to the sun, leading to drier and hotter, and even desertification. The globe warming is proved by disappearing millennium glacier on high mountains.

From late fall to early spring in the northern hemisphere, the air temperature of temperature-constant ocean is higher than the land air temperature, so clouds are gathered above big ocean or a part thereof is sucked to southern hemisphere, which generally decreases heavy land rainfall of the northern hemisphere. Cloud will affect surface temperatures of the Earth, so increase of the cloud will also enlarge a temperature difference between winter and summer, which meant there will be extreme cold and extreme hot, and so a truth is.

Global warming will heat land surface and sea water, and air is not constant in temperature while the land surface and the sea water are. In cold seasons, when dense cloud layer covers an area from the sun or in a period of no sun, the land air of the area will be quickly cooled while a land surface has not yet cooled, which caused a temperature difference. However, the hot land surface and the cold air contact with and suck each other, so as to produce fog. Sudden cold air of the area will be strongly sucked by uncooled areas or warm ocean air, resulting in sudden strong cold wind and cooling. That is to say, increase of the Earth clouds will produce more cold weather or strong winds.

Rain times have been reduced, which shrinks and loosens soil, especially mountain soil due to lack of water. Furthermore, in recent years, rains were mostly highly-concentrated strong thunderstorms, so a lot of rainwater will increase a weight of loosened mountain soil. The rainwater will also easily penetrate into the mountain or underground through the loosened mountain soil, which almost transforms the soil into fluid washes away with water. As a result, landslides, mudslides and land subsidence are easy to happen. Mountain plants are difficult to survive due to decrease of the rain times and thus lead to desertification. In fact, the above natural disasters have occurred more frequently in recent years.

There are a few explanations of lower temperature during snow melting rather than snowing. According to the present invention, an explanation is as follows. As mentioned above, clouds will provide “strong greenhouse effect”. Because snow falls from the clouds which are hotter than air, there is no extreme cold during snowing (except for blizzard with strong cold wind). However, when cold and thick snow on the ground begins melting, there is no cloud in the sky. Therefore, the ground is colder during snow melting rather than snowing.

Processes of Gathering Cloud Layers and Automatic Compression Thereof

Cloud containing moisture is heavier than air. During daytimes of summer, clouds will be hotter due to sun exposure and thus rise higher, and will be cooler due to night or rain and thus fall. In warm seasons, direct sun will evaporate and raise a lot of water from seas, lakes, rivers, wetlands, green lands, etc., which forms a large number of low-altitude small cloud groups. The small cloud groups will be sucked by near low atmospheric pressure zones or areas with highest above-below average temperatures, and thus move. The small cloud groups will also rise while move.

During riding and moving, a lot of hot cloud layers will suck each other and become larger and denser big cloud groups or small cloud layers. The cloud groups or layers rise at different time of areas, and then reach the low atmospheric pressure zone. Therefore, the cloud layers are generally divided in to a top layer, a middle layer and a bottom layer.

When the sun obliquely shines the clouds, the clouds facing the sun are hotter and the clouds on the other side are cooler. As a result, the cooler clouds will be sucked by the hotter clouds, which is a reason for rapid change of cloud group shapes. Tther reasons comprise cloud group self-compression from outside to inside and rapidly rising cloud group center point.

In warm seasons, some cloud groups will stay when reaching a hottest area or a center position of the active low atmospheric pressure zone, but will eventually rise due to a high temperature. Due to thinner air and higher wind speed at a higher altitude, the dense cloud groups will spread and become thin scattered clouds. When a lot of the gradually rising scattered clouds get together, localized high clouds are formed, gradually into changes the sky form blue to blue-white, then white or gray, and so on. The cloud layers remain in the area and are gathered to be larger, thicker, denser, hotter and more constant in temperature, while the central position thereof is the densest, thickest and hottest. Such cloud layers will not be as flaky as winter cloud layers.

The more the cloud layers are, the more the sun will be blocked, which cooling the ground air which is originally hot. Because heat at a high altitude is provided by heat at a low altitude, cooling the ground air equals to cooling the cloud layers. At this time, upper cold clouds will fall due to being cooled and thus pressure against lower hot clouds. At the same time, the hot air rising from the ground will support the lower clouds, which provides “top-bottom compression” to all layers and then forms a single dense cloud layer. The dense cloud layer is better at cooling the ground air. The single dense cloud layer will then automatically provide “top-bottom inter-compression” and push from outside to center for forming an extremely thick and dense cloud layer. As a result, the clouds at the center are hotter.

If there is another cloud layer beside the huge and hot dense cloud layer, convection will be formed, because two hot cloud layers suck each other, or the larger one sucks the smaller one. After convection, the cloud layer will be denser and hotter, which accelerates processes of “top-bottom compression” and “outside-center compression”, and makes the cloud layer closer to the ground, thicker, extremely dense and extreme hot, like a large Mongolian yurt. The above is formation rainstorm, tornado or huge typhoon. Before exceptionally strong thunderstorms or tornados, cloud layers will instantly be black due to the above reasons.

A temperature will be increased by 6 degrees Celsius if an altitude is decreased by one thousand meters, so air pressure and density are higher. Therefore, the temperature and density of the above pressed-down dense cloud layer will quickly rise, which increases temperatures below the cloud layer and on the ground (strong greenhouse effect). As a result, the weather will be very hot, which is similar to a principle that a construct is hotter when a bottom thereof is lower. The cloud layer as dense as a water curtain, especially the clouds at the central position and the air below will be finally heated to a limit and rush upwards, which generates strong thunderstorms, strong wind shear, hail or tornados at the center position or a hottest location of the cloud layer.

Natural methods for releasing hot and high-pressure air under the dense cloud layers are usually by common and mild thunderstorms, then hail. Severe methods comprise releasing by tornado or typhoon. If artificial rain is provided at the hottest position of the cloud layers for releasing, the above weather disasters are able to be avoided.

A few examples are provided below to prove that clouds reaching hot limit will rapidly rush upwards at the center position of the cloud layers: in summer sunny days, cloud columns at a center position of a large cloud group with clear outline due to exposure to the sun and slow movement rapidly rush upwards, which is frequently observed by naked eyes, wherein the cloud columns is visible from the ground. Meanwhile, by observing a top portion of the central position of the hot larger cloud group through a telescope, it can be seen that the hot clouds at the top portion rise with a relatively high speed and slightly move up and down. A reason for slightly moving up and down is similar to raising upper water by hotter lower water during heating water, which proves that the clouds at the central position of the cloud group is hotter. When observing a top portion of the dense cloud layers from a plane, it is also able to be seen that some columnar clouds appear at the central position which is densest among the cloud layers, and the columnar clouds are surely dense and bright.

However, clouds at a top portion of a hottest position of a large cloud layer with is thick of thousands meters is not columnar but slightly convex in a circular form, because the huge and thick cloud layer is generally at a high altitude with a low temperature, and the thick cloud layer is not easy to be fiercely heated by the sun or the heat rising from the ground. Therefore, the temperatures of the clouds at the central position and air below rely more on internal convection effect of heat transform between clouds, so as to be gradually heated to the limit, and thus will not rush upwards like the small hot cloud group.

Heat gathered by the gradually heated hug cloud layer and hot air gathered below are thousands times more than that of the small cloud layer. When the clouds at the central position and the air below are gradually heated to the limit, the huge amount of heat will rush upwards for being released with a larger range and a stronger force, which forms the above weather disasters.

If the above cloud layer is formed on a tropical ocean with even temperatures, due to the sea air temperature is constant, day and night temperature difference is small, and air flow is stable, the cloud layer is more gradually heated than the cloud layer above land, and will not be affected to rain by unstable strong air impulse. There is a lot of how moisture rising on the tropical ocean, which will quickly and steadily increase clouds. As a result, the cloud layer above the sea [a typhoon cloud layer] will be gradually gathered to a diameter of thousands kilometers, and a thick o up to twenty kilometers.

For a larger, thicker and hotter cloud layer, clouds at a central position thereof and air below will certainly be hotter. Such two heats will absorb a large amount of clouds and air around the dense cloud layer. The clouds and air flowing from outside to inside of the cloud layer forces the cloud layer, especially the clouds at the central position, to rise and not spread to surrounding locations. Therefore, the thickness of the whole cloud layer increases, and the central location is thicker to be round convex.

The above cloud layer is surely at a central position of a hug active low atmospheric pressure zone. Hot air generated by a low atmospheric pressure and the huge cloud layer (strong greenhouse effect) will gradually spread to surrounding areas, leading to a wide range swelter. In fact, before a typhoon arrives, a rear is extremely sweltering. Such hot clouds, especially the hot cloud at the central location and a huge amount of hot air below are further heating for a long time before finally reaching a hot limit and automatically releasing at the central position of the cloud layer, which forms a typhoon with a central wind eye.

Since the top portion of the central position of the above hug cloud layer is slightly convex in the round form, it can be observed by satellites that the cloud layer at the central position is slightly convex, bright or snow white and hot. Observing from the ground or the sea surface, the hottest position at the center of the cloud layer is black, and air below the position is hot and wet like thin fog with a shape of V. However, the V shape is only able to be seen from a distance, for example, from ocean and extremely large plain. It is like a rainbow which is also only able to be seen from a distance. To find the center or the hottest position of the cloud layer, besides observing the thickness and density with the satellites, measuring the temperature of the cloud layer and humidity and temperature of air below with instruments, naked eye observation from a distance is also adaptable.

According to the above explanation, it is proved that before the formation of a tornado or typhoon, the large cloud layer (especially the center position thereof) at the active low atmospheric pressure zone is able to be observed and measured by naked eyes from above and below the cloud layer besides by a variety of meteorological instruments. In fact, satellite images show that cloud layers surrounding a formed typhoon eye are slightly convex, which proves that before formation of the wind eye, the central position of the typhoon cloud layer has been convex.

Causes of Active Low Atmospheric Pressure

A definition of the active low atmospheric pressure is that an atmospheric pressure of an area is “temporarily” lower than atmospheric pressures of neighboring areas. Because air is easier to laterally move than rise, so even slight atmospheric pressure difference is able to generate lateral wind. In order to better understand causes and processes of weather disasters, it is necessary to work on complex causes and processes of the active low atmospheric pressure•[which is also called low pressure circle below] first.

Natural-formed active low atmospheric pressure is only formed within a large space and cannot be formed within a small space. For example, the atmospheric pressure of a hot non-sealed room equals to an outdoor atmospheric pressure, but sealed cabin is able to artificially increase pressure.

Due to gravity, air density and pressure become higher when the air gets closer to the ground, and the air density and pressure become lower when the air gets farther from the ground. Therefore, there is a strong “fixed high-low-altitude pressure difference” within a short range between a high altitude and a low altitude. In general, the “high-low-altitude pressure difference” does not produce rapid updraft.

According to conventional theories, it is believed that the active low atmospheric pressure is formed by cloud convection. The conventional theories also does not mentioned that the low atmospheric pressure is gradually formed by expansion of hot air, which is most likely because there is no record of the above “above-below average temperature” according to the conventional theories. If only the ground temperature is used as a standard, it will be considered that the low atmospheric pressure is not generated by high temperature, because atmospheric pressures of extremely hot desert areas are quite high.

According to the present invention, it is considered that the temporary “active low atmospheric pressure” is formed by gradual expansion of large-range warm or hot air, especially of the cloud layers which absorb and store heat, and is constant in temperature. That is to say, the active low atmospheric pressure is gradually formed before cloud convection. For example, a tropical atmospheric pressure is always lower than a frigid zone atmospheric pressure, and an atmospheric pressure at a warm afternoon slightly lower than an atmospheric pressure in a cool morning, which are just regular or routine low atmospheric pressure difference.

An above-below average temperature change of an area may cause frequent atmospheric pressure increase or decrease of the area, and above-below average temperature change may be affected by cloud increase of decrease, sun rise or fall, rain or not, low-temperature cloud layer or not, air flow, etc. For example, the atmospheric pressure usually rises after rain (after air and cloud layers are cooled and decreased). An atmospheric pressure of an area may also be increased or decreased by surrounding moving low atmospheric pressure. For example, the atmospheric pressure will dramatically drop due to a typhoon with an extremely low pressure.

As described above, a hot large cloud layer will dramatically increase an above-below average temperature of an area [except for cold cloud layers which just enter from a cold zone], which indicates the strong active low atmospheric pressure is formed by large hot cloud layers which move freely. A formed active low atmospheric pressure (which is a huge cloud layer) moves laterally for forming strong winds. For example, “typhoon” or “tropical depression” movement will generate storm disaster on the way. In fact, the above weather disasters are all generated in the active low atmospheric pressure zone.

Causes of the active low atmospheric pressure are very complex, which is mainly because of a lot of clouds gathered or staying at an area with a relative high above-below average temperature for a long time. As the Earth getting hotter, there will be more clouds and the clouds will be more gathered, leading to a higher temperature. Therefore, the strong low atmospheric pressure is more likely to be formed, which will surely suck far clouds at surrounding areas, in such a manner that high atmospheric pressures related to landforms are formed at the surrounding areas, which generates extremely high temperatures or drought.

In summers, in areas with a lot of clouds and high temperatures, there will be a plurality of independent low pressure circles within a range with a diameter of about 5000 kilometers, which proves the low pressure circles are formed by a lot of clouds and high temperatures. When an above-below average temperature of an area is increased and a lot of clouds are gathered, due to the cloud layers in the air will continuously and gradually absorb and store heat for increasing a temperature, and then the air in the area will slowly expand for lowering an atmospheric pressure, the atmospheric pressure will only be gradually decreased and will not be dramatically decreased. If the low atmospheric pressure is rapidly formed or dramatically decreased, disastrous sharp strong winds will frequently happen on Earth surfaces.

After cloud convection happens in an area, clouds and density of hot cloud layers will truly be increased rapidly. Because clouds, which rapidly gets denser, is able to absorb and store heat while prevent hot air from normally rising, an above-below average temperature of the area will be significantly increased, in such a manner that an atmospheric pressure of the area will be significantly decreased. The above results may be why some theories believe that the active low atmospheric pressure is formed after the cloud convection.

The low atmospheric pressure will gradually return to a normal atmospheric pressure, but the returning process is faster than a lowering process because the cloud layers in the low atmospheric pressure zone will rain and thus cool the clouds and air. The movable low atmospheric pressure will strongly absorb high-pressure air outside the area for produce a strong wind, which is able to reduce the temperature within the low atmospheric pressure zone, in such a manner that the low atmospheric pressure returns faster, wherein that is one of the reasons why a “typhoon” or “tropical depression” with the extremely low pressure is able to form the strong wind on the way.

Since raining will quickly reduce the above-below average temperature for increasing the atmospheric pressure, artificial rain is a harmonious method for rapidly increasing the atmospheric pressure and reducing the clouds.

The above-below average temperature of an inner-ring of the low atmospheric pressure zone is the highest, which means the atmospheric pressure is the lowest. The atmospheric pressures of a middle-ring and an outer-ring are not that low, and the atmospheric pressure outside is normal. If the extremely low atmospheric pressure of the inner-ring is not isolated from the normal atmospheric pressure in the above gradual form and is close to the normal atmospheric pressure, disastrous sharp strong winds will happen on Earth surface.

Although the low pressure circle is huge, it is tiny when compared to the entire surface of the Earth. Therefore, the whole low pressure circle moves following the Earth atmospheric circulation or is sucked by neighboring areas with high above-low average temperatures. However, cloud layers of typhoons, storms of other types or thunderstorms are all at the inner-ring of the low pressure circle.

Based on the above theory, typhoon, which itself has an extremely low pressure, will follow an entire huge low pressure circle to move laterally, that is why the typhoon with the extremely low pressure will also move laterally. When the low pressure circle passes through an area, an atmospheric pressure of the area will be instantly decreased. The strong active low atmospheric pressure is able to raise a sea level [tide]. Especially, tide below a wind eye with an extremely low pressure will be raised higher. Strong winds combined with high tide will cause a huge wave, and so a truth is.

In summers, a ground of an area will cause localized heat or drought because clouds of the area are strongly sucked away by strong active low atmospheric pressures of surrounding areas. In fact, in recent years, due to the above reason, localized extremely hot areas (active high atmospheric pressure zone) frequently appears while areas nearby suffer localized or concentrated rainstorm (active low atmospheric pressure zone). The above explanation also proves that increase of the Earth clouds will make is easier to form the localized extremely high temperature or drought. For example, a lot of clouds are easy to generate typhoons and super typhoons, while the typhoons will absorb a huge amount of clouds.

As described above, after the global warming, the hot cloud layers are difficult to be cooled to rain. As a result, the cloud layers need to be gathered for being extremely large, thick and dense before generating exceptionally strong thunderstorms or other weather disaster. That is to say, if the cloud layers are artificially prevented from being gathered for being extremely large, thick and dense, the extreme weather problems such as typhoons, tornados, severe localized flooding, extremely high temperatures, droughts, uneven rain zones and serious air pollution are able to be solved.

Because the atmospheric pressure at the inner-ring of the low pressure circle is low, the clouds will be sucked to be thicker, denser and hotter. Therefore, the large hot cloud layers inside the low pressure circle will not flow out of low pressure circle, and will only rise within the low pressure circle and get thicker, denser, hotter and more constant in temperature, until being heated to the limit. The dense cloud layers are also able to prevent hot exhaust gases from normally rise.

Therefore, wet and hot air gathered below the hot cloud layer will also be continuously heated to be extremely sweltering, and the hot air will absorb cool air nearby, including polluted air, which increases the concentration of PM2.5. Accelerating of the globe warming will worsen the above situation.

Further Detailed Description of Formation of Active Low Atmospheric Pressure

Since the causes of active low atmospheric pressure are extremely complex, extremely detailed description should be further illustrated, and some significant natural phenomenon must be given to prove the theory of the description. In addition, according to the description, cloud sizes, thicknesses and densities are different, and weathers of different seasons and periods differ from a weather of a time of the present invention, so the description cannot provide uniform temperature figures. According to the description, the thickness of the hot cloud is set to four kilometers, in order to provide a unified interpretation.

Although the active low atmospheric pressure is formed after temporary expansion of the hot air, areas with a sunny weather increasing a ground temperature are active high atmospheric pressure zones, while the low atmospheric pressure formed by the high temperature appears at areas with low ground temperatures on the contrary. A reason thereof is that the temperature forming the active low atmospheric pressure is not just the ground temperature, but the “above-below average temperature” of the ground and a high altitude.

An area with a high above-below average temperature will absorb a lot of clouds. When a thick hot cloud layer with a diameter of hundreds kilometers is gathered at the area, a [troposphere] above the area is relatively hot. When a large hot cloud layer which is static or moves slowly is gathered above at the area, the temperature-constant hot cloud layer will heat a four-kilometer-thick space where the cloud layer is. The hot space together with the strong greenhouse effect will keep the ground air of the area hot during day and night. In this case, the long-term high above-below average temperature of the area will lead to slow air expansion and thus gradually form the active low atmospheric pressure.

In fact, a temperature of a night with the dense cloud layer is higher than a temperature of a nigh without the dense cloud layer, which was reported by US meteorologists. In that year, after reviewing records, the US meteorologist discovered that when New York City was under a flight ban due to 911 counter-terrorism problems, a lot of clouds caused by planes disappeared. Because cloud layers are able to produce a temporary greenhouse effect, a night temperature of New York during the flight ban was lower than a night temperature without the flight ban.

The above explanation shows that although daytimes of desert regions or drought regions with a large day-night temperature difference are hot, nights thereof are cool, clouds hardly rise from the desert regions or the drought regions, and there are few clouds nearby. Therefore, it is difficult to gather enough clouds and keep a high above-below average temperature for a long time. Besides, there is no greenhouse effect, so it is to form an active low atmospheric pressure and rain. The above explanation also describes a formation condition of the active low atmospheric pressure is enough clouds and the long-term high above-below average temperature.

The active low atmospheric pressure is formed by slow expansion of hot or warm air within a large range space of a localized area. The large range space comprises a dense cloud area with a diameter of hundreds kilometers, a space between a ground and a cloud layer, and a four-kilometer-height space occupied by a thick dense cloud layer [four-kilometer-thick] with a diameter of hundreds kilometers.

The above-below average temperature of the above large range space together with effects of the low atmospheric pressure and high humidity [i.e. the strong green house effect] are able to force some insects to climb out of a ground, which proves that the “strong greenhouse effect” formed by the dense cloud layer will generate high temperature and humidity within the large range space at the Earth surface. However, a sunny area only has a high ground temperature, while humidity thereof and a temperature of sky above the sunny area are low.

In summers, sky of a high atmospheric pressure zone is deep blue due to no “altostratus”. When the sky is bluer, the sun shine the ground more directly, in such a manner that ground air is hotter. However, a large range sky thereof is relatively cool due to no large hot cloud layer, which shows that the “above-below average temperature” of the high atmospheric pressure zone lower than the one of the low atmospheric pressure zone.

In order to easily understand the formation process of the active low atmospheric pressure and a reason why the high and low atmospheric pressure zones often change locations, following data are used. The data are only for defining high and low temperatures.

For example: an area has a hot cloud layer with a diameter of hundreds kilometers and a 1 km distance from a ground; a thickness of the hot cloud layer is 4 km, which means a distance between a top thereof and the ground is 5 km. Because the cloud layer is able to prevent heat of the sun from reaching the ground, the ground of the area with the cloud layer is relatively cool, but the cloud layer itself, which is 4 km thick, is hot.

A ground of a cloud-free area is unprotected from the sun, a ground temperature thereof is higher than a ground temperature of a cloud layer area, while a sky temperature is high than a sky temperature of the cloud layer area. According to calculated results below, an above-below average temperature of the cloud layer area is higher than an above-below average temperature of a cloud free area. Therefore, an atmospheric pressure of the cloud layer area is lower.

A reason why the active high and low atmospheric pressure zones often change locations is as follows: for example, an A area is a high atmospheric pressure area without large cloud layer [but there are small cloud groups], then a sky thereof is of course deep blue. Without cloud, the sun is able to directly shine the ground, in such a manner that the ground air temperature of the A are is increased to, for example, 34 degrees Celsius which is dry and crisp.

It is a natural law that a temperature will be increased by 6 degrees Celsius if an altitude is decreased by one thousand meters, so when the ground hot air of the A area reaches an altitude of 5 km, a temperature thereof is 34−(5×6), i.e. 4 degree. Therefore, the “above-below average temperature” of the ground and the sky of the A area is (34+4)/2, i.e. 19 degrees Celsius.

A B area near the A area is an active low atmospheric pressure zone with a 4 km-thick hot cloud layer, and the hot cloud layer is 1 km away from a ground, which means a top of the is 5 km away from the ground. Although the sun is blocked by the 4 km-thick hot cloud layer of the B area, which leads to a low ground temperature, the B area is affected by a “strong greenhouse effect” factor. Therefore, the ground temperature of the B area is slightly lower than the 34 degrees Celsius of the A area, i.e. 30 degrees Celsius which is sweltering.

Although a temperature will be increased by 6 degrees Celsius if an altitude is decreased by one thousand meters, there are the hot cloud layer and the “strong greenhouse effect” factor above the B area, so the sky temperature of the B area is higher than that of the A area. Therefore, in theory, a temperature of a position 1 km away from the ground of the B area with the hot cloud layer is lowered by 4 degrees Celsius instead of 6 degrees Celsius, i.e. 30 degrees Celsius minus 4 degrees Celsius. That is to say, the temperature of the position 1 km away from the ground of the B area is “26” degrees Celsius.

Cloud layers will absorb and store the heat of the sun. The 26-degree hot clouds 1 km above the B area will surely transmit heat to clouds above, and thus greatly increase a temperature of the clouds above. Although the 26-degree hot clouds will be cooled during transmitting the heat upwards, the 4 km-thick cloud layer is already hot. Because the dense clouds containing moisture are connected to each other like water, it is easy to transmit the heat upwards. Therefore, the temperature of the 4 km-thick cloud layer above the B area is relatively average, which is different from dry air whose temperature drops by 6 degrees Celsius when an altitude is increased by one thousand meters. Based on the above theory, a “total average temperature” of the 4 km-thick cloud layer above the B area should be about 18 degrees Celsius. Thus, an above-below average temperature of the ground and the sky of the B area is (30+18)/2=24 degrees Celsius. However, the above-below average temperature of the A area whose ground temperature is higher is only “19” degrees Celsius. Therefore, the B area with higher above-below average temperature is the low atmospheric pressure zone.

If there are some cloud groups or small cloud layers above the A area, the cloud groups or small cloud layers will be sucked by the hot cloud layer and low atmospheric pressure of the B area, in such a manner that the cloud layer of the B area becomes thicker and thicker, resulting in a disastrous weather. ON the contrary, the cold ground air of the B area will be sucked by the hot ground air of the A area, especially when the ground air of the B area is rapidly cooled due to rain, which is a reason why up and down flows around and within the low pressure area mostly move in opposite directions. In fact, the weather and wind direction in the low pressure zone is quite instable. For example, some tornados are not vertical due to a flow direction of a cloud layer is opposite to a flow direction of ground air.

According to the present invention, the cloud thickness is relatively thin. If the cloud layer of the B area is larger, thicker and denser, the above-below average temperature thereof will be higher, resulting in lower active atmospheric pressure. In fact, when typhoon or thunderstorm cloud layers with an extremely low atmospheric pressure is approaching an area, a lot of clouds above the area will rapidly flow to the typhoon or thunderstorm cloud layers.

The B area with the low atmospheric pressure will finally suffer heavy rain, exceptionally strong thunderstorms, or other disasters. Because the rain will rapidly cool the cloud layer and the air below, strong winds will be generated. Both the wind and the rain will cool the hot cloud layer and the ground air, and an amount of the clouds will be reduced due to the rain, which gradually returns an original very low atmospheric pressure. On the contrary, after the ground the A area with no cloud (high atmospheric pressure) is exposed to the sun for a long time, the temperature thereof will be high. The high temperature combined with rising hot clouds evaporated from the ground will gradually increase the low above-below average temperature of the A area, until the above-below average temperature of the A area is higher than that of the B area after rain.

Clouds are gas containing moisture rather than liquid. If a density thereof is not high enough, the clouds will not completely stay in the B area and form rain. Because the clouds and air are cooled by the rain, cold clouds above the B area will be absorbed by the A area with a high above-below average temperature. As a result, the B area will be transformed into a blue sky area and gradually become a normal atmospheric pressure zone, which is called “after rain the sky looks blue”.

Light hot air is able to rise to an extremely high altitude and then disappear, but heavy clouds only rise to a certain height and stay, so as to be the altostratus of the A area. As a result, an original deep blue sky of the A area is changed to blue and white, white or gray, and the A area will gradually become a low atmospheric pressure zone. In fact, in recent years, when an area suffers serious localized flooding, neighboring areas thereof are often extremely hot due to sunny weathers, is consistent with the above situation.

Tiny sand grains and drought areas are less constant in temperature. Desert areas and the drought areas are hot during days but cold at nights. In evening, cold clouds of the drought areas quickly spread, or sucked away by neighboring areas which is hot and constant in temperature. The above explanation shows that the drier an area is, the hard it will be to form an active low atmospheric pressure, while it is easy to form the active low atmospheric pressure at cloudy offshore areas or hot ocean which is constant in temperature day and night. If the cloudy A area is able to keep the above-below average temperature higher than the one of the surrounding areas at cool night, the low atmospheric pressure is able to be remained.

Under normal conditions, active high or low atmospheric pressure zone is able to be transformed into the other one in a short period. However, during warm rainy seasons with a lot of clouds due to the global warming, when a lot of hot clouds continuously flow into a raining low atmospheric pressure zone with a lot of hot and humid rising air, a cloud amount of the area is quickly supplied. Therefore, the low atmospheric pressure thereof remains and rainstorm lasts, leading to serious floods.

In fact, the rainy seasons often happen during warm seasons, and the low atmospheric pressure is easy to be formed or maintained for a long time at provinces near a sea. According to the above explanation, the active low atmospheric pressure is mainly produced by the clouds. In rainy seasons, south China Southern, or some offshore areas suffer a long term heavy rain because of the above reason, which leads to serious flooding.

Clouds are sucked by areas with high “above-below average temperatures”. Weathers are not able to be accurately predicted if the meteorologists only calculate the ground temperature and ignore the above-below average temperature.

A Reason why Storms of Northern Hemisphere Mostly Rotate in a Counterclockwise Direction

According to the conventional theories, counterclockwise or clockwise rotation of storms depend on Earth “bias”, Earth “magnetic field” or other effects. However, such explanation is not logical, detailed or proved. The above natural phenomenon is indeed very complicated. Therefore, without understanding discoveries of the prevent invention, especially the natural strong sensing capability, it will be difficult to explain the above phenomenon.

According to the present invention, a unique explanation is as follows: a huge large hot cloud layer and hot air staying in the low pressure circle will strongly absorb hot clouds and air nearby. That is to say, cold clouds and cold air in all directions around the cloud layer will quickly flow in and impact the cloud layer, which will move the cloud layer. Because the hot clouds cannot flow out of the low pressure circle while the hot clouds must move, the hot clouds are only able to rotate with a small curvature and a low speed. In fact, according to satellite images, huge cloud layers within the low pressure circle all rotate with small curvatures and low speeds.

An air temperature of an area is highest at a period after the area has been directly exposed to the sun for 1-2 h, i.e. afternoon or when the sun is to the west of the area. Clouds or air is good at sensing temperatures and atmospheric pressures, which will be driven forwards by the nearest and hottest air.

At the northern hemisphere, when the clouds of the above cloud layer begin to rotate with a small curvature and a low speed, the clouds will be firstly sucked by hot air directly exposed to the sun and thus move to the west. Because the clouds rotate with the small curvature rather than straightly move with a low speed, the clouds which are sucked to the west will be secondly sucked and move towards an equator direction [south]. Combination of the above two moving directions or the rotation direction is counterclockwise. A principle of clockwise rotation in the southern hemisphere equals to the above interpretation.

After the huge cloud layer begins to slowly rotate in a certain direction, the direction cannot be changed and rotation remains. Certainly, a variety of storms generated within the huge dense cloud layer will follow the above rotation direction. The above explanation reveals a mystery that the storms in the northern hemisphere mostly rotate in the counterclockwise direction, while the storms in the southern hemisphere mostly rotate in the clockwise direction.

A basic atmospheric pressure of an equatorial region is relatively low because of the above described reasons. The atmospheric pressure is formed by long-term and continuous expansion of the hot air. Because ground and sea surfaces of the equator have a regular high temperature, high-speed rising of hot air will lead to a regular high temperature above the equator. Therefore, an equatorial above-below average temperature is always high, resulting in a regular low atmospheric pressure.

Although day time ground temperatures of some high-latitude inland areas to the north of the equator [including large desert areas] is up to 50 degrees Celsius during some summer periods, above-below average temperatures thereof are not high due to a small amount of clouds above the areas. In addition, a temperature difference between day and night is large. Thick and dense cloud layers are difficult to be gathered under such conditions, so an atmospheric pressure thereof is high. Therefore, a regular atmospheric pressure thereof is generally higher than that of the equatorial region.

Causes and Formation Processes of Hail

Hail is solid water falling from an extremely thick and dense cloud layer, whose diameter is generally about 0.2-0.6 mm, and 8 mm at most. Hail falling from a central position of the cloud layer may be bigger, which is able to do great harm to crops, livestock and humans. When the cloud layer is denser and thicker, hot air rising from the ground is more and stronger, and the hail formed is bigger. The hail is able to quickly cool air below the cloud layer or cool ground air.

A basic formation principle of the hail is almost the same as the tornados, typhoons, thunderstorms, etc. A main cause thereof is that after the strong greenhouse effect is generated by the dense cloud layer, clouds at the central position of the cloud layer and hot air below are heated to a limit and rapidly rush upwards.

The hail is impacted and borne by the hot air and hot dense cloud which rapidly rush upwards, so as to rotate with a small curvature and roll up and down in the dense clouds. Therefore, a falling speed thereof is low, which provides a long period for the hail to absorb moisture in the dense clouds and grow. An area suffering the hail will not be large because the hail is only able to be generated at the central position of the cloud layer. Hailing will not last long because the hail is only able to be produced when the hot air rushes upwards, which is generally not long-lasting.

A density of the hail is lower than a density of common water and a density of artificial ice, so transparency or transmittance thereof is weak, but reflectance thereof is strong. Additionally, the hail used to roll in the cloud layer, so the hail is white and round. White is a sunlight color, whose reason is the same as a reason why colors of snow and cloud under the sun are white. Colors of iridescent clouds, rainbow, waves and waterfalls are all colors of light.

Causes and Formation Processes of Tornados

Tornados can be divided into land tornados and waterspouts, wherein the waterspouts are generated above oceans or inland lakes. The tornados are able to be formed at any season. According to the present invention, the tornados are divided into long-lived, short-lived, warm season and cool season tornados, wherein causes and formation processes thereof are provided.

A bottom diameter of the tornado is only a few meters at least, and generally about hundred meters to one kilometer. A top diameter of a funnel shape is usually one kilometer, and 10 kilometers at most. A tornado pressure is quite low, which will lead to a high rotation wind speed. If the cloud layer is thicker, denser and hotter, the pressure is lower and the wind speed is stronger. Strongest tornado wind speed is up to 500 km/h, which is high enough to blow away people, cars, houses, etc., which has a great destructive power. An active period of the tornados is much less than an active period of typhoons, which is usually a few minutes, but very few tornados are able to last for about one hundred minutes.

The tornado is a hollow cloud column extending from the dense cloud layer to the ground, while ground air is continuously sucked upwards with a high speed inside the cloud column. Up to now, experts have not been able to explain the magical contrast phenomenon. However, the present invention has figured out the phenomenon. Some experts classify causes of desert small dust devil and causes of the tornados into a same catalog by mistake. If the experts believe causes of the dust devil and the tornado area the same, the causes of the tornados will be more complicated.

Different from some conventional theories, the tornado is not formed by “airflow rotation” due to convection of two cloud layer, or kept active (alive) by “continuously rushing upwards of hot air”. If so, the tornados of the northern hemisphere will not only rotate in the counterclockwise direction, and the tornados of the southern hemisphere will not only rotate in the clockwise direction. In theory, when two cloud layers collide with each other, a rotation direction is uncertain.

With the above conventional tornado formation theory, it will be mistaken by people that sudden disappearance of the tornado is caused by sudden disappearance of hot air. In fact, a tornado life power is remained only by sucking high-pressure air with low-pressure one, and the power always exists. Although most of the cloud columns will be broken by stretching and bending, or disappear due to an insufficient density of the cloud columns, some cloud columns (the tornados) without stretching and bending are able to last for about 100 min, which proves the convention theory is wrong.

The following are natural laws and natural conditions for tornados: a higher altitude leads to a lower pressure; a lower altitude leads to a higher pressure; low-pressure air sucks high-pressure air; hot air or hot clouds suck cold air or cold clouds; cloud, which is more constant in temperature than air, absorbs and stores heat of the sun or heat rising from the ground; a larger, thicker and denser cloud layer leads to a higher temperature, a central position of the cloud layer is even hotter; a dense cloud layer is hotter when closer to the ground layer, a temperature thereof may be higher than a temperature of air below the cloud layer or above the ground; air rotates when rapidly rising due to suction, because it is lighter in such a manner.

A large, extremely thick and dense hot cloud layer close to the ground is a necessary condition for producing tornados. For example, after convection of two cloud layers, the cloud layers will rapidly become denser and hotter. After rapidly becoming denser and hotter, the cloud layers will “self-compress” to be even denser, closer to the ground and hotter, in such a manner that the cloud layers are able to instantly make the sky dark. Denser cloud layer will blocks more sun light, thus rapidly cool the ground air. As a result, if the hotter cloud layers are closer to the ground, cooled ground air will be more closely contacted, which forms a short-distance temperature difference with the ground air, so as to generate a “temperature difference suction power”.

When the temperature of the cloud layers are further increased to extremely high due to self-compression, the hot clouds will rush upwards at the central position or the hottest positions of the cloud layer and generate hail or thunderstorms. As a result, the ground air will cooled again by the hail or heavy rain in no time. Then a greater temperature difference is formed between the hot cloud layers and the cooled ground air. With the sudden increase of the temperature difference, the hot clouds at the central position or the hottest position of the cloud layers cooperate with low-pressure sky air to strongly suck low-temperature and high-pressure ground air, which generates a high-speed rotation updraft, strong wind, strong wind shear or tornado on the ground below the cloud layers. A landing plane near a track will suddenly fall if encountering with a following wind shear.

A common ocean cloud layer only has one hottest position. For example, a typhoon has only one central wind eye. However, a land cloud layer may have more than one hottest position. In a so-called tornado town, the United States, a huge cloud layer is able to generate a plurality of typhoons, because an extremely large plain, which passes through America from a south to a north, has a low altitude and no high mountain. As a result, extremely large dense cloud layer which is close to the ground and flat is easy to be formed. The lower the altitude is, the denser and hotter the cloud layer will be. Tornado also happens during US winters, especially when clouds have been increased due to globe warming.

Brief causes of a winter tornado are given below. For generating the winter tornado, there must be large thick dense cloud layer close to the ground at first. When the cloud layer gets denser, more sun light will be blocked for further lowering a ground temperature, which will generate strong cold winds on the already cold ground at the same time.

Based on the natural law that a low pressure and a high temperature suck a high pressure and a low temperature, when the cloud layer temperature is higher than the air temperature below the cloud layer, the cloud layer is quite close to the ground, temperature differences thereof contact closely with each other, and there are strong cold winds, the low-pressure air in the sky and the hot cloud layer will strongly suck high-pressure and cool air on the ground, which will lead to the tornado. In fact, when there is a relatively thick cloud layer at an area, a rising speed of the high-pressure ground air is always high. For example, during a period of dense clouds and winds, one can often see that some waste paper rises to an extremely high altitude themselves.

In sunny days, some desert dust devils will be sucked upwards by hot cloud groups and form a shape like a tornado or waterspout, such as a strange dust devil in a photo often seen on internet. However, causes of such dust devil have not been explained by any conventional theory. Some people mistakenly believe that the dust devil is a tornado in sunny days. According to the present invention, dust devils are mostly generated on hot or dry desert. As described above, the ground temperature of the desert is much higher than the air temperature. Once a sudden strong gust of strong wind gust happens, the dust devil will be generated because the gust rotates. If there is a hot large cloud group, which is close to the ground, above the dust devil, the dust devil is likely to be absorbed by the hot cloud group and thus form a dust column like a waterspout.

Since the causes and formation processes of the tornados are complicated, and there is a slight formation difference between tornados of cold and warm seasons, only causes and formation processes of the tornados of the warm seasons, which is common and strong, are explained in detail below.

A tornado is hollow cloud column rotating with a high-speed, which rush to the ground from a central position or a hottest position of an extremely dense cloud layer in a rotation form. Nature activities are slowly accelerated, so a rotation speed of the tornado will gradually be extremely quick.

The American low-altitude extremely large plain is able to produce most oldest and strongest tornados, because there are seas or big lakes on the east, south, west and north of the area, Therefore, a huge amount of clouds close to the ground are absorbed from all directions, particularly from south and north. A landform of the extremely large plain is not complex; for example, there is no high mountain (high mountain airflow is unstable, in such a manner that cloud layers are not able to be gathered and be flat for generating tornados). Because of no high mountain blocking, clouds coming from north to south do not need to rise high and then run. As a result, the United States is able to gather large dense cloud layers which are relatively close to the ground, hot and flat, wherein the cloud layers coming from south and north will provide cloud convection, and tornados are almost formed after the cloud convection.

A low altitude of an area equals to a low altitude of cloud layers above the area, wherein the low-altitude cloud layers after self-compression area able to be about 200 m from the ground or less. Based on the above explanation of cloud self-compression, the cloud layer density after hot cloud layer convection is almost doubled. In addition, with “cloud layer internal convection”, the density will be further increased, in such a manner that the center position of the cloud layer will be denser and hotter, which instantly makes the sky dark. In fact, before formation of the tornados, the cloud layers are black.

Since the heat of the sun is rapidly blocked by the denser cloud layers, the ground air temperatures under the cloud layers, especially under the central position of the cloud layers will dramatically drops, resulting in a cyclone or turbulence. When a great temperature difference is formed between the cooled ground air and the hot cloud layers, and the cyclone or the turbulence is formed, the high-pressure cold ground air will be sucked upwards by the central position of the hot cloud layers, which instantly forms a tornado. Since hail or thunderstorm is not necessary before formation of the tornado generated by the cloud layers which are quite close to the ground, the temperatures and measurements of the cloud layers will not rapidly drop, so as to provide a longer life and a stronger strength.

Short-life tornados are almost formed on plains which are not extremely large and have low altitudes, wherein cloud layers of such tornados are far from the ground, and the tornados are usually formed after strong thunderstorm or hail. Before formation of the short-life tornados, clouds which are heated to a limit will firstly rush upwards from the hottest position of the cloud layers, while the high-pressure hot air gathered below the cloud layers will also instantly rush upwards with the hot clouds for releasing a rising pressure of the high-pressure hot air below the cloud layers.

When the hot clouds at the position and hot air below rapidly rush upwards, localized strong winds, wind shears, thunderstorms or hails will be generated on the ground. Because clouds at a top portion of the extremely thick cloud layer are already in the extremely cold sky, rain drops of such thunderstorms are relatively big and cold. The big and cold rain drops will suddenly cool the air below the central position of the cloud layers for forming strong winds or cyclones, which almost likes the hail.

Cloud layer convection is able to rapidly double the density and temperature of the cloud layer; the cloud layer whose density is doubled will doubly block the sun and cool the ground air; sudden thunderstorm or hail further cools the ground air and thus produces strong winds. The three factors will all suddenly cause huge temperature difference between the cloud layer and the ground, in such a manner that high-pressure cold air on the ground is sucked upwards, leading to strong wind shear, cyclone or tornado. In fact, the short-life tornados are always a moment after a hail or strong thunderstorm.

The sensitive and flexible nature prefers an easy way. Since updraft in a rotation form is light, the airflow which is rapidly sucked upwards will rapidly rotate, which is different from airflow rush or spurt upwards. For example, hot volcanic ashes are spurted upwards and blast dusts rapidly rush upwards, so there is no rotation.

At beginning of the above suction process, the airflow sucked upwards is slowly accelerated to rotate, which generates a “centrifugal force”, and the centrifugal force will form the hollow cloud column. However, after continuous increase of the rotation speed, continuous high-speed rotation will generate a “centripetal force”, which decreases a size of the hollow cloud column but increases a density of a column body. Explanations of the centrifugal and centripetal forces are: when discharging a bathtub, water slowly rotates at beginning of being sucked downwards and thus generates a large whirlpool, but the faster the whirlpool rotates, the thinner the whirlpool will be. A diameter is of the tornado is small because the tornado is only formed in a center point which is hottest in the cloud layer, and rotates with an extremely high speed.

At an early stage of the formation of the tornado, the rising speed of the high-pressure ground air sucked is gradually increased, which firstly forms the hollow cloud rotating with the high speed inside the cloud layer, so as to communicating an upper portion with a lower position of the cloud layer. The density of the cloud column is quite high, so the cloud column is like a hollow straw formed by the extremely dense clouds Since there is a huge altitude difference between upper and lower ends of the extremely dense cloud column of the column body (which is usually more than thousands meters), a extremely low pressure at a high altitude will strongly suck the high-pressure below the cloud layer upwards only through the cloud column (which is the hollow straw). The stronger the suction power is, the faster the cloud column rotates, wherein with a faster rotation speed, the density of the cloud column is higher, which is proportional.

Most cloud columns are hidden inside the extremely dense and thick cloud layer, and an observed cloud column is only a tiny part [which is about two hundred meters or less] of the entire cloud column. The closer the ground is, the higher the pressure will be, so a ground surface pressure is the highest. Based on the natural law that low-pressure air sucks high-pressure air, it is a natural instinct that the low-pressure air sucks “highest-pressure air” at all cos.

Since the cloud column is only formed by the rapidly rotating clouds, the cloud column is able to extend freely or shrink a little. Additionally, because the extremely sensitive nature is able to strongly sense atmospheric pressure differences, and a rotation effect as well as a suction effect is both able to slightly stretch the cloud column, the high-altitude extremely low-pressure air will definitely suck the highest-pressure ground air through the cloud column which is easy to extend.

When suction power and rotation power of some cloud layers are not strong, only a dangling funnel cloud extends downwards from below the cloud layers [in fact, the funnel cloud often appears below some thunderstorm dense cloud layers]. When suction power and rotation power of some hotter and denser cloud layers are extremely strong, rotation thereof drives the cloud column, which is easy to extend, to rush to the ground, which only aims to suck the highest-pressure air on the ground, which is the same as a spiritual person, animal, or even plant who naturally and easily extends hands, heads roots or branches for picking up better food or obtaining better living conditions. In fact, a micro sensing capacity of the nature, which does not rely on advanced education and has no visual and auditory senses, is stronger than that of humans.

The above conditions illustrate why the cloud column with an interior up-sucking power extends downwardly on the contrary, and stops once reaching the ground. When the suction power and the rotation speed are decreased due to decrease of the density of the cloud column, the cloud column will retreat into the cloud layer. Such phenomenon may be the most difficult part to be explained by the conventional theories, so tornados are considered to be magical.

Suction action will move the straw towards a sucked direction [which is contrary to spurting]. Therefore, a bottom of the cloud column automatically moves towards a sucked area. Because moving directions of the tornado cloud layer and ground air are not necessarily the same, some of the cloud columns will be rapidly inclined, stretched or over-distorted by airflow with an opposite direction.

The upper end of the hollow cloud column communicates with the extremely-low air at the upper portion of the cloud layer, and the lower end of the hollow cloud column communicates with the high-pressure air on the ground. Therefore, a pressure at the lower end of the cloud column is able to be assimilated by the extremely low-pressure air at the upper end of the cloud column. In recent years, after a group of scientists enjoying chasing tornados tested tornados with instruments, it was found that the pressure at the lower end of the cloud column is very low, which is consistent with the theory of the present invention.

Before a tornado is formed, hot cloud layer will firstly provide a high humidity and a sweltering situation of the ground air below the cloud layer, but at a formation moment of the tornado or during tornado activity, the ground air temperature is relatively low [which is typically about 26 degrees Celsius or below], which proves that the tornado is mainly maintained by sucking high-pressure air by low-pressure air rather than hot airflow which rushes upwards. In fact, the hot airflow does not often appear, while suction power generated by high-low pressure difference always exists.

A destructive power is high speed rotating airflow together a strong suction force, wherein the suction power is able to lift a medium goods vehicle dozen meters off the ground, and the high-speed rotating airflow is able to break a tree into halves, so as to provide serious damage on the ground. Since the cloud column is formed by gas rather than liquid or solid, heavy objects suck upwards will be thrown out of the cloud column by the rotation centrifugal force. However, a waterspout is liquid, so fishes sucked up will not be thrown out of the waterspout.

“Waterspout” is often generated between summer and fall, because water, which is constant in temperature, is hot only during such period. After midsummer, there are fewer tornados but more strong typhoons, because during this period, clouds are more likely to be gathered above tropical oceans.

Causes of “waterspout” are as follows. Firstly, a hollow cloud column falls to a water surface. After the hollow cloud column sucks water and turns into a hollow water column, the cloud column returns to a cloud layer. Because a density of the water column is higher than a density of the cloud column, a straw whose density and suction power are higher than that of the cloud column is able to be formed. Therefore, fishes are able to be sucked to an extremely high altitude and blown away, and then land on a land which is far away. In fact, falling fish is often heard.

Enough height [length], density and suction force are necessary for the water column to suck the fish to the extremely high altitude, which proves a great part of the water column, like the cloud column, is inside the cloud layer, or the fishes are not able to be sucked to the extremely high altitude. The water column is formed by water, which is sucked upwards rather than extends downwards as the cloud column. Therefore, the water column is strip-shaped instead of funnel-shaped. The water column is also easy to be stretched or bent, leading to being broken or disappearing.

Theoretically, diameters of the cloud column are constant at different parts (like a straw), so as to generate a powerful suction force. An external part of the cloud column looks like a funnel because the upper end thereof is at a high altitude, hence clouds surrounds an external part of the upper end, wherein the higher the altitude is, the more cloud there will be, so a shape is more like a funnel. An effect of high-speed rotation will certainly keep a top end of the cloud column very round and smooth. It is very round and smooth because the effect of high-speed rotation will tow more clouds, while the centrifugal force or the centripetal force generated by rotation will keep the clouds at inner sidelines of the cloud column Therefore, the entire cloud column is hollow.

A formation theory of the hollow cloud column is the same as a formation theory of the typhoon wind eye formed by rising hot airflow which rapidly rotates. When extremely high-speed airflow rises in a rotation form, a wind eye thereof is extremely round, hollow, or opened. When the speed of the updraft is not high, the wind eye is not round or opened.

A wind eye of a huge typhoon also has airflow, which is like a tornado, rotating and rising due to suction. However, because the wind eye is huge, a rotation speed thereof is certainly not as fast as a tornado which is extremely thin and fierce. As a result, the airflow rising at the wind eye is relatively thin and thus difficult to be seen within a short distance. However, the huge thin cloud column under the wind eye is able to be seen dozens kilometers away on ocean.

The suction force of natural low-pressure air is slowly increased. If the suction force is quickly increased as a pump, there will be disastrously sudden strong winds on the Earth. At beginning of rotation of a thin rotating dust devil on a desert, a rotation speed thereof is slow, so a diameter thereof is large. When the rotation speed becomes faster and faster, the diameter will become shorter, which is an example of slow acceleration and the centripetal force. Although detailed explanation of the dust devil is provided by the present invention, the main causes and formation processes of dust devil and tornado are different.

A life of a tornado with a rainstorm is relatively short, because when a cloud layer becomes rain and decreases, the tornado disappears. Since a color of a short-lasting and slight tornado formed a moment after falling of heavy thunderstorm is the same as grey and white of the sky during heavy rain, and a rotation speed of airflow is not high and a density is low, thin rotating airflow of the tornado is difficult to be seen by naked eyes.

Cloud convection may happen at any time, so tornados may happen at night, especially for low-lying areas with higher temperatures. Hot dense cloud layers at such areas are difficult to be cooled into rain during daytimes. As a result, a high temperature of the dense cloud layer remains till night. Because clouds at an upper portion of the cloud layer is not exposed to the sun, the clouds will be cooled and lowered to pressure against clouds at a lower portion of the cloud layer, and then combined with each other for forming a single extremely dense hot cloud layer, in such a manner that the single dense cloud layer is closer to the ground and thus hotter. When cloud convection occurs, together with a “cloud layer internal convection” effect, the hot cloud layer will be hotter, which is easy to form tornados.

Causes and Formation Processes of Typhoons

According to international classification, when a maximum wind power is less than 8, it is called a “tropical depression”. When the wind power is 8 and 9, it is called a called “tropical storm.” When the wind power is 10 and 11, it is called a “strong tropical storm”. When the maximum wind power reaches 12, it is called a “tropical cyclone”, “typhoon” or “hurricane”. A lot of clouds is needed for forming a typhoon, which means an atmospheric pressure thereof is extremely low, so as to suck a lot of clouds nearby.

An atmospheric pressure at a wind eye of the typhoon is quite low, which is able to not only produce strongest winds, but also produce a high tide. Huge waves generated by the typhoon is able to overturn boats, endanger traffic safety and do damage to coastal facilities; heavy rain generate by the typhoon is able to cause flood, torrential flood, landslides, etc., which damages crops, destroys houses and threaten lives, resulting in huge economic and property losses to a wide range of people.

A typhoon damage area is larger than a tornado damage area, but strong winds produced by the typhoon are different form the strong winds of the tornado which are concentrated in a small range and rotate fiercely. The atmospheric pressure is low at the wind eye has basically same causes as the tornado whose atmospheric pressure at the lower end of the cloud column is extremely low. Although the tornado is thinner than the typhoon, the cloud layer of the tornado is denser and hotter (land cloud layers are denser due to being hotter). As a result, the rotation wind speed thereof is fiercer. Furthermore, the cloud column has a small size and is concentrated, so the destructive power therefore is extremely strong.

The present invention believes that the typhoon and the tornado are able to be classified as a same family, because natural rotation storms are almost in same mode. The formation processes of the huge typhoon have common in that of the thin tornado, both of which are generated by the clouds at the central position of the cloud layer after being heated to the limit and rushing upwards, so the rushing process of the hot clouds are not given in this chapter

A main purpose and technology of the present invention is to prevent formation of typhoon or hurricane, tornado, severe flooding, serious urban air pollution, and so on, but a method for weakening an already formed typhoon or hurricane is also provided. Therefore, not only cloud layer gathering processes and formation processes of a typhoon or a hurricane are provided in detail in this chapter, but also running processes thereof are given.

Up to now, Causes of stable air flow at a wind eye have not been really explained, and such phenomenon is still listed as an “amazing natural phenomenon”. The present invention believes that winds of the typhoon are strongly sucked upwards at the wind eye. The airflow at the wind eye is stable because the air flow is sucked up at the wind eye in a rotation form, and the rotating air flow will closely press against a wind eye wall and rise, which means the airflow at a center of the wind eye is stable.

There used to be a news report that after a front of a wind eye passed across an area, some people of the area went outdoor because about airflow was table at the wind eye with has a diameter of about forty kilometers. When a rear of the eye arrived, the people were sucked several meters high by strong updraft, and blew a dozen meters away at the same time, which confirms the above explanation.

Based on observation of meteorologists, it is found that when the water at a beginning of formation of a typhoon, sea water below a central position of a typhoon cloud layer will rotate and a lot of moisture will rotate and rise, which is consistent with the “similar causes of typhoon and tornado” of the present invention. That is to say, there are fiercely rotating wind power and suction force below the wind eye. Since the rotating rising moisture is thinner than the cloud column of the tornado and the wind eye is huge, the moisture is only visible from a very long distance.

Power sources of the typhoon are a huge amount of hot clouds and a huge amount of hot air gathered below. The huge amount of the hot clouds and hot air is gathered in a huge low pressure circle is hot. Especially, clouds at a central position of a cloud layer and hot air below are hotter, and hotter cloud and air will absorb cloud and air from all directions more quickly, which makes the central position of the cloud layer and the air below hotter and denser. Natural typhoon is generated for cooling the huge typhoon cloud layer and releasing a rising pressure of the huge amount of the hot air below.

As described above, before the formation of the typhoon, the extremely huge typhoon cloud layer in the active low atmospheric pressure zone has already been slowly rotating. If the cloud layer is larger, thicker and denser, the cloud layer will be hotter. Therefore, clouds at the central position are hottest, so as to produce faster “cloud layer internal convection”, which makes a cloud rotation speed at the central position is faster than a cloud rotation speed at a non-central position. When the clouds at the central position is heated to the limit, the clouds will centrally rush upwards in the rotation form, and the rushing hot clouds will drive the high-pressure hot air below the cloud layer, in such a manner that the high-pressure hot air will be strongly sucked up by the extremely low-pressure air with a fast rotation speed. A rising speed due to being sucked will gradually increase, which will generate the centrifugal force and the centrifugal force will open a huge round channel [the wind eye] inside the cloud layer.

All kinds of storms exist within a huge active low pressure circle. “Typhoon”, “strong tropical storm” or “tropical depression” is actually the same class or same cloud layer, wherein an only difference is being strong or weak. When the “tropical depression” or “strong tropical storm” has been greatly enhanced, a wind eye appears to become a typhoon. After the typhoon is weakened, the wind eye disappears, and the typhoon becomes the “tropical depression” again, while the tropical depression is also able to bring a lot of rain for a land. Based on the above explanation, the wind eye is regarded as a “heart” for the typhoon by the present invention.

Since the sea water is more constant than the land in temperature, the land air is heated or cooled quickly. Based on this theory, air and clouds rising from the sea are relatively constant in temperature. A land environment is complex, so there are great temperature differences between different positions. For example, there are plateaus, mountains, deserts, lakes, rivers, valleys and hot cities on the land, which have different strengths on absorbing and reflecting heat while air temperature increasing speeds thereof are also different, resulting inconsistent and unstable heights, temperatures, flow directions and flow speeds of the clouds above the land. Furthermore, because the cloud layer on the hot land will rapidly become extremely dense and hot, severe rainstorms and tornados are easy to be caused. As a result, there is no stable environment on the land low-pressure circle for forming an extremely large and thick typhoon or hurricane cloud layer.

A hottest period of sea water of a tropical ocean is when the sea water has been exposed to the sun for about 30 days. In summer of the northern hemisphere, when the sun light returns after reaching a tropic of cancer, reaching and returning trips means the sun stays at the tropic of cancer for a long time [which is longer than a one-way trip for the sun to pass the equator]. If coupled with factors that daytimes are longer than nights and the sea water is constant in temperature, ocean between 10-25 degrees near the tropic of cancer is hottest between mid-summer and mid-autumn, while typhoons or hurricanes formed during this period are strongest.

Although the <equator> is the nearest area from the sun, there is no reaching and returning trips from the tropic of cancer. In addition, there is unique strong hot air rising from the equatorial areas, so it is difficult for the equatorial areas to generate huge typhoon or hurricane cloud layers.

Because the North Atlantic with high latitude is relatively narrow, and sea water thereof communicates with sea water of the Arctic which is relatively cold, temperatures of the sea water and air above are not high. Also, the North Atlantic is close to continents at two sides and shares same latitude, and too close distance between sea and land will lead to a great temperature difference, which causes high flow speeds of air and cloud layers. Therefore, winds and waves on the North Atlantic are always strong, while the high speed of wind is difficult to generate hurricane cloud layers. The great temperature difference will also generate strong storm disasters [which are not hurricane] at both sides. In fact, both sides of the North Atlantic always suffer from strong winds with a speed up to one hundred kilometers per hour.

Based on the above explanation, there are few ocean areas on the Earth which is able to generate typhoons. For example, ocean areas being too narrow, too close to continents, at same latitude with continents, and too high or low in latitude are not easy to generate typhoons. As mentioned above, Cloud layers are easy to be gathered above small sea islands, so huge typhoon cloud layers are easy to be formed above archipelago areas on big oceans. In fact, most typhoons or hurricanes are formed above small islands on big oceans. The fact that typhoon cloud layers are easy to be formed above archipelago areas on big oceans complies with the above-mentioned “theory that cloud layers are easy to be gathered above mountain tops or tropic sea islands”.

The Middle Atlantic and Pacific are wide, which are not at the same latitude as the hot continents. As a result, there is no short-distance great temperature difference. In fact, airflow above the Middle Atlantic and Pacific is more stable than that of the North Atlantic. There are more archipelagos at the Northwest Pacific, so huge typhoon cloud layers are easy to be formed therein.

Fast-moving cloud layers are difficult to form strong typhoons. For example, from late spring to mid-summer, because the continent air which is not constant in temperature is rapidly heated and the sea air which is constant in temperature is slowly heated, a temperature therebetween is relatively large. As a result, the hotter continent air will quickly sucking cool sea clouds, and the fast-moving non-circular clouds will only bring a lot of rain for the land or form <tropical depression>, leading to few strong typhoons. From mid-summer to mid-autumn, the temperature-constant sea water has already been heated by the sun, wherein the temperature difference between the sea water and the continent is small. Therefore, the sea clouds will not be rapidly sucked by the continent.

A day-night temperature difference of the continent not constant in temperature is large, which is opposite to the ocean. Airflow at tropical ocean areas not too close to the continent is stable, so large, thick, dense and hot typhoon cloud layers are easy to be form in such ocean areas. Below such cloud layers, a huge amount of hot air is continuously and stably produced and stored. The “cloud internal convection” in an extremely large cloud layer is relatively intense, so the cloud layer is more circular. However, a central position of the circular cloud layer is relatively hot, which will form a typhoon with a central wind eye. In fact, during the above period, extremely large cloud layers formed over the ocean are usually circular.

In summers when daytimes are longer than nights, temperature-constant tropical ocean is able to evaporate a lot of clouds during day and night, so as to form extremely large cloud layers. The sea water which is hot during both day and night keep the cloud layer and air below being constant in temperature and hot for a long time. From mid-summer to mid-autumn, the ocean water temperatures of tropical Pacific and Middle Atlantic are about twenty-seven degrees Celsius or more, sea water with such temperature is able to be sixty-meter-deep and constant in temperature, and thus constantly generates hot water vapor during day and night, which rises and then becomes clouds.

Cloud layers above the ocean are quite close to the ocean (which means a low altitude). That is to say, the cloud layers and a huge amount of air below are relatively high in temperature, pressure and density. Because of the low altitude, the hot clouds uploads heat to high-altitude cold clouds which a stable and even speed, which is difficult to rain. Therefore, an ocean environment has longer time for the cloud layers to be larger and thicker, which a diameter is up to 1000 km and a thickness is up to 20 km or more. Of course, the huge cloud layer will certainly self-compress for being denser and hotter, which further lowers the atmospheric pressure. In fact, a strong typhoon pressure is extremely low.

A huge typhoon cloud layer is surely within a low pressure circle, and there must be a huge amount of hot air below the huge typhoon cloud layer. The hot air and a low atmospheric pressure will gradually spread to a periphery of the low pressure circle. Due to a huge size, the periphery is relatively far from an internal ring of the low pressure circle, so there is no strong wind. As a result, the periphery is usually sweltering due to no wind. In fact, before a typhoon is formed or arrives, the periphery of the low pressure circle is often breezeless and sweltering.

Typhoons formed between summer and fall are often sucked by a northwest or north hot continent, while typhoons after late fall are often above oceans or moves to the west rather than lands the north continent, because the north continent which is not constant in temperature suffers from cloud rain and flow after mid-autumn, in such a manner that the atmospheric pressure is relatively high and the typhoon is not able to be sucked. For example, in early November 2011, a super typhoon <petrel> moved slightly to the west (towards Philippines). An amount of typhoons in year 2011 was increased by six when compared with year 2010, which, together with appearance of the petrel, proves the theory of the present invention: global warming and increase of clouds will certainly lead to more and more severe weather disaster.

A formed typhoon [low-pressure circle] is sucked by a nearest front with a high above-below average temperature or a lower atmospheric pressure, thereby moving step by step without certain direction. Therefore, a moving direction of the typhoon is uncertain. During a typhoon season, because above-below average temperatures of continent coastal areas are generally lower than that of the seas, the entire low-pressure circle will be sucked by the continent and thus move, while the typhoon inside the low-pressure circle only positively moves with the entire huge low-pressure circle. The above explanation illustrates why a typhoon with an extremely low atmospheric pressure moves laterally rather than stays at a generating area of the extremely low pressure.

Based on the above factors, typhoons or hurricanes will generally move towards west ocean or island countries, and north-west or north hot continents rather than east ocean coast. However, when there are two typhoons (two huge low-pressure circles) which are close to each other, one of the typhoons will temporarily move to the east due to an <inter-sucking effect of low pressures>. When the typhoon counters continental sudden cold flow or a high atmospheric pressure, the typhoon will turn to hot sea areas which is constant in temperature or a neighboring east hot island country.

The typhoons formed above oceans are all sucked by northwest areas, which means southeast coastal continent areas have a lot of rainfalls; as a result, no desert is formed at an eastern part of the continent. However, deserts will be formed at low-altitude inland areas, which are at a western part of the continent and are away from coasts, due to little rain and hot temperatures, and so a truth is.

Besides absorbing heat from the sun and heat rising from the sea at daytimes, the typhoon cloud layers also obtain a lot of hot moisture from temperature-constant sea water at nights for supplement of typhoon heat and cloud amounts, which provides a stable and sufficient living condition for the typhoon. Because cloud amounts and heat above oceans are stable and sufficient, the typhoon power source is able to be long-term supplied. Therefore, the typhoon is able to maintain the low atmospheric pressure and high temperature for a long time, so as to continuously absorbing clouds and air nearby. Furthermore, sufficient hot airflow rotates and rises through the wind eye for a long time to keep the wind eye being round, so a continuously raining typhoon is able to survive for a relatively long time above the ocean.

The hotter the airflow below the typhoon cloud layer is, the faster the airflow rises through the wind eye, which makes the wind eye more circular, thinner and more opened. However, a life of a tornado is counted in minutes, because the tornado is just an extremely dense rotation cloud column. Once a density of the cloud column is not enough or the cloud column is stretched and broken by opposite airflow, the tornado will disappear.

A rotation power generated when the hot airflow is sucked up by the wind eye will strongly and continuously drive clouds near the wind eye to rotate and reach a high speed. The rotation power is able to continuously draw huge cloud layers, whose diameters are hundreds kilometers or thousands kilometers, to form a rotating round cloud circle [which is called a storm circle below].

Due to a factor that cloud layers at a central position of the storm circle are relatively dense and hot and other factors such as a centrifugal force generated by an extremely low pressure and high-speed rotation of the wind eye, cloud cohesion and suction are stronger at such position. Therefore, clouds at the storm circle not only never spread, but also strongly absorb a lot of clouds. As a result, the clouds at the central position of the storm circle are able to maintain a strong state. In recent times with globe warming, warm sea water and many clouds, the clouds at the central position of the storm circle will be thicker, stronger and hotter, thereby making the typhoon stronger or easier to be enhanced.

Hot air below the typhoon cloud layer is concentrated and strongly sucked to be above the cloud layer by a high-altitude extremely low pressure, so the wind eye is similar to a channel or brick neck for releasing the hot air below the cloud layer. In fact, the infinite suction power at the high altitude is extremely large, the updraft strongly sucked must be faster and concentrated when passing through the brick neck, and the updraft quickly sucked must be rapidly replenished. Therefore, there are continuous and strong winds where the wind eye passes.

The above explanation shows that wide sky with the extremely low pressure is an outlet of the huge amount of hot air gathered below the typhoon cloud layer. Another proof of that the hot airflow below the typhoon cloud layer is sucked up through the wind eye is as follows: when the wind eye is to the east of an area and has not arrived at the area, strong wind in the area flows to the east. Once the wind eye passes through the area, and is to the west of the area, the strong wind will instantly flow to the west, which also proves that the wind is sucked up through the wind eye. In fact, typhoon strength is rated mainly based on a distance between a wind eye and an area.

The larger, thicker and denser the typhoon cloud layer is, the lower the atmospheric pressure will be, and the more and hotter the hot air below will be. If the atmospheric pressure is low, then a wind speed is high, and the airflow sucked up needs to pass through the wind eye with a higher speed. Air which is sucked to rise will rotate with a high speed, which will produce a centripetal force, and the centripetal force is able to make the wind eye small and extremely round. With a higher speed of the rotating updraft, the rotation force drawing the clouds within the wind eye is stronger, which will make the wind eye more smooth, wherein being smooth means no scattered cloud within the wind eye (which means the wind eye is opened). In fact, when the wind eye becomes small, very round and opened, the wind speed of the typhoon is relatively strong.

The diameter of the typhoon wind eye is generally about forty kilometers, and the height thereof is up to twenty kilometers. When the wind eye becomes thinner because of the “centripetal force”, the air which is sucked up must pass more quickly due to a thinner brick neck, which is similar to rivers whose flow speed needs to be increased for keeping an original large flux when pass through a narrow valley.

The “tropical depression” has no high-speed rotating circular storm circle or wind eye. Although winds generated by the tropical depression is not like the typhoon which is sucked up in a rapid and concentrated form through the obvious and tiny wind eye, because various storms are all laterally moving low atmospheric pressures, strong winds will still be generated where the tropical depression passes through.

Strong winds generated by cloud layers of the no-wind-eye “strong tropical storm”, “tropical depression” and rainstorm are also generated by sucking the hot airflow below up through the hottest central position of the cloud layer from a high-altitude area. In recent years with the globe warming, after encountering a long-term high temperature above a hot ocean, a “strong tropical storm” or “tropical depression” is also able to be enhanced and become a typhoon with a wind eye.

Whether a typhoon is strong or weak depends on a temperature and a speed of rising hot air. Freely falling rain of the typhoon is difficult to cooling a huge amount of temperature-constant sea water and rising hot moisture, so it is difficult to decrease the temperature and density of the typhoon cloud layer and the amount of the clouds (while it is easy to artificially increase rainfall). Therefore, some typhoons running above the sea is able to keep enough energy until landing, while others will be weakened or disappear during running. In modern times with the globe warming, most typhoons have gotten enough energy for landing.

Once landing, due to a large land day-night temperature difference, few clouds and large land environment changes, the typhoon will be instantly weakened or become the <tropical depression>, while the tropical depression will also bring a lot of rain to the land.

Rapid rotation of the typhoon does not rely on the power of the low pressure circle which rotates slowly, and if so, the wind eye would not be very round. However, the wind eye is maintained very round only by continuous rapid rotation airflow which passes through the wind eye. The above theory proves that the rapidly rotating typhoon is driven to rotate by the hot airflow which rapidly rotates for rising though the wind eye.

For a huge round wind eye at a middle of a high-cohesion cloud layer for a long time, it is necessary that rapid and strong rotation airflow continuously passes through and presses against clouds beside a wind eye wall, which will lead to a centrifugal or centripetal force. As a result, the clouds beside the wind eye wall need to bear a strong outward pushing force and a traction force, so the clouds at such position must keep an extremely dense state.

After formation, a typhoon needs to maintain and rely for a long time on a rotation speed which has already existed for stably running above a sea, so the typhoon needs to frequently maintain the width or the round shape of the naturally formed wind eye. Only high-density clouds are able to provide a stronger traction force or driving force, while the traction force only depends on the non-solid dense clouds. As a result, the wind eye wall and the clouds nearby require an enough density for making and keeping the wind eye extremely round. When the typhoon lacks power sources, the rotating updraft will decelerate, and then lose the (centrifugal force) or (centripetal force), i.e. lose the wind eye. Therefore, the typhoon will be weaken and become a “tropical depression”, and that is why a typhoon will be automatically weakened or disappear.

Because there is no brick neck (tunnel) communicating with the extremely low-pressure air above the cloud layer after the wind eye disappears, there will be no concentrated and rapid high-pressure air rising through the wind eye, in such a manner that there will no super wind speed. Therefore, by artificially expanding, deforming or eliminating the wind eye, the typhoon is able to be decelerated or even eliminated. In fact, a large country had tried some methods for weakening hurricanes, which is described in detail below.

Some typhoons or storms of other types will be enhanced again after being weakened, and an enhancing requirement is that there must be conditions which is conducive to enhancement encountered on the way, such as passing through a hot and cloudy sea for a long time on the way, and gradually building up energy for enhancement after staying at a hottest area such as a <Gulf of Mexico> with hot sea water in North America, or South China Sea.

Because the <Gulf of Mexico> is in hot south of the North American and is almost surrounded by lands, hot sea water is difficult to flow out and cold sea water is difficult to flow in, which keeps a high temperature. The <South China Sea> with same latitude has an almost identical geographical environment, so the sea water is hot and cloud amounts are large at such two positions In fact, there were a lot of typhoons or hurricanes staying at the positions before being enhanced or returning. The typhoon will return because an above-below average temperature is higher above a sea behind the typhoon or an atmospheric pressure is lower than that of a land where the typhoon directs.

Effects and Functions of Artificial Rain

Cloud layers able to form the above weather disasters are quite hot and extremely dense. Artificial rain firstly turns clouds into rain drops. Since the rain drops falls from cold clouds at a high altitude, the thicker or higher the cloud layers are, the colder the rain drops will be. The cold rain drops are able to absorb clouds at a middle altitude during falling, so as to become larger rain drops. The large and cold rain drops will cool hot and dense clouds at an artificial rain area (which is a central position or a hottest position of the cloud layer).

After being artificially cooled, the hot clouds at the above position will be sucked by uncooled clouds nearby and spread, and the cold clouds and the hot clouds contact with each other for being cooled into rain, resulting in self-expanding of a rain area. In fact, once a central position or hottest position of a large “thunderstorm dense cloud layer” begins to rain, clouds nearby will rain in sequence. Raining will lower the cloud density, so sweltering air below the cloud layer will normally rise and be released through a position whose density has been lowered.

In summer, raining will firstly produce hot moist on a ground which rushes upwards, rushing hot air will condense the dense clouds and automatically generate rain. Wet hot air rushes upwards will cause lightning, and sounds of the lightning will shake the dense cloud, which will also stimulate the rain area to automatically rain heavily.

Heavy rain is able to quickly reduce temperatures of grounds and ground air. Due to high-altitude temperature is supported by air rising from the ground, cooling the ground means cooling the high-altitude cloud layer. Therefore, the cloud layer will be further cooled into rain. After the high-altitude cloud is cooled, the cold clouds above the cloud layer will press downwards for compressing the clouds below the cloud layer, so as to increase the cloud layer density and continue to rain. After a thunderstorm cloud layer rains, rest clouds in the heavy rain area will also quickly flow out, leading to blue sky above the area, which is called “after rain the sky looks blue”, and a sweltering situation will also disappear. The above effects are able to make the cloud layer to unconditional produce the above natural disasters.

Method for Preventing Formation of Above Weather Disasters

The object of the present invention is to provide people a method for preventing formation in advance of tornados, typhoons, strong thunderstorms, strong wind shear, severe urban air pollution, etc. The method is a simple method of artificial rain.

The causes and formation processes of the above weather disasters, the characteristics and gathering laws of the clouds, the causes and formation processes of the low atmospheric pressure, the density increase and self-compression processes of the cloud layer, an identifying method of the central or hottest position of the cloud layer, cloud layer characteristics which are able to form tornados or typhoons, geographical locations and environments, wind eye characteristics and effects thereof, processes of the typhoon running above the sea, etc., are illustrated above in detail. Therefore, besides measuring with satellites and instruments, artificial analysis is needed for preventing the above weather disasters.

Modern meteorology, meteorological satellites and other technologies have been advanced. Meteorologists are able to measure an atmospheric pressure of an area, temperature and humidity increase or decrease of ground air or air below a cloud layer, cloud size, thickness, density, temperature, flow direction, gathering position, thickest and densest position, whether there will be strong cloud layer convection, etc., which are all recorded.

Because of the above weather disasters are all formed in extremely dense cloud layers with high temperatures, so long as a proper artificial rain position is set and cloud layer convection and cloud layer internal convection are prevented with a proper artificial rain method for prevent cloud layers from being extremely dense, thick and hot, the formation of the above weather disasters are able to be prevented.

Whether the gathering process of the cloud layer is fast or slow, whether the cloud layer temperature is high or low and so on depend on factors such as a season at that time, geographical environments, temperatures, periods, whether an atmospheric pressure is high or low, whether a cloud amount is large or small, etc. Therefore, it is difficult to establish consistent data.

During rainy seasons or non-rainy seasons, such as months without strong monsoon, temperatures some low-altitude modern cities such as Beijing, China, are higher than temperatures of surrounding areas, in such a manner that dense cloud layers are easy to be gathered. As long as the cloud layer is transformed into rain water in advance or properly, the cloud layer and the air below are cooled, which not only reduces the density of the cloud layer, but also drives out the cloud layer gathered above the city. The method is able to solve problems of PM2.5 and city flooding.

The central or hottest position does not need to be defined as being large. Based on various theories above, the present invention defines a diameter of the central position of the huge round typhoon cloud layer as twenty to forty kilometers, preferably twenty-five kilometers. A diameter of the hottest position of the long land tornado or storm as ten to thirty kilometers, preferably fifteen kilometers. Therefore, just short-term artificial rain provided at the central or hottest position is able to prevent the formation of the above weather disasters.

The method for preventing the above weather disasters mainly comprises a step of: before a cloud layer which is able to cause the above disasters is gradually developed or formed, reaching a certain density, thickness and temperature due to “cloud layer internal convection”, or before the cloud layer sucks a neighboring cloud layer (i.e. before cloud layer convection), decreasing a cloud amount, temperature and density of the cloud layer by artificial rain, which is simple and safe.

The above object is able to be achieved with a following embodiment, wherein a method according to the embodiment comprises steps of:

wherein according to the present invention, positions, causes, formation processes and other factors which are easy to generate the above weather disasters are figured out; after fully understanding the present invention such as theories, explanations, methods and illustrations, experienced meteorologists are able to measure on site with conventional equipments and technologies for obtaining an actual condition of the cloud layer, and analyze a developing speed thereof, so as to determine whether the cloud layer will lead to the above weather disasters, and whether or when to provided the artificial rain; and

determining whether the cloud layer has a condition for forming the above weather disaster at a season and area which are easy to generate typhoons, tornados, exceptionally strong thunderstorms, etc., wherein for example, a large dense cloud layer close to a ground or sea is easy to from the above weather disasters; before the cloud layer gradually develops (comprising cloud layer convection and cloud layer internal convection) to be larger, denser, thicker and hotter, thereby automatically leading to the above weather disasters, which means before clouds at a central position of the cloud layer and air below are rapidly increased in temperature and humidity, and thus automatically rush upwards with a high speed, dropping artificial rain agent at an up-middle portion of a cloud layer within an entire range of an artificial rain band 3 for providing the artificial rain.

Dropping at a top portion of the dense cloud layer is most effective. For example, after being cooled, clouds at the top portion will drop and press downwards, in such a manner that the cloud layer is further denser and continuously rains. As described above, the typhoon cloud layers are mostly formed above islands in tropical oceans, so an artificial rain base may be established on the islands.

Referring to the drawings, the present invention is further illustrated. The drawings are sketch views of artificial rain band positions according to the present invention.

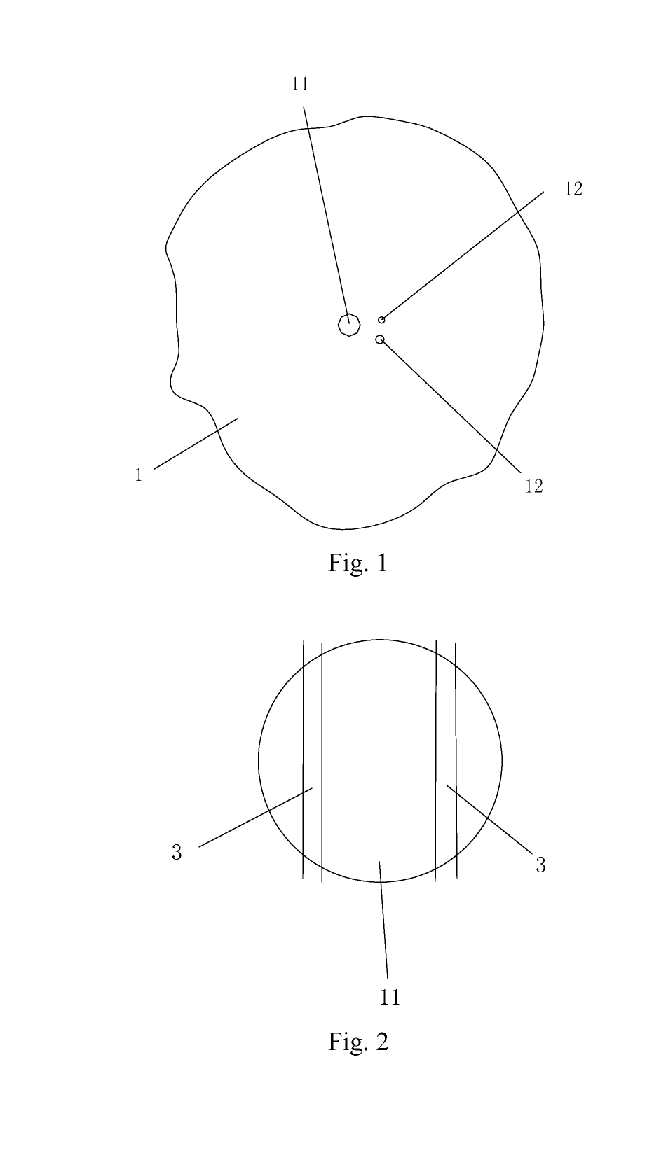

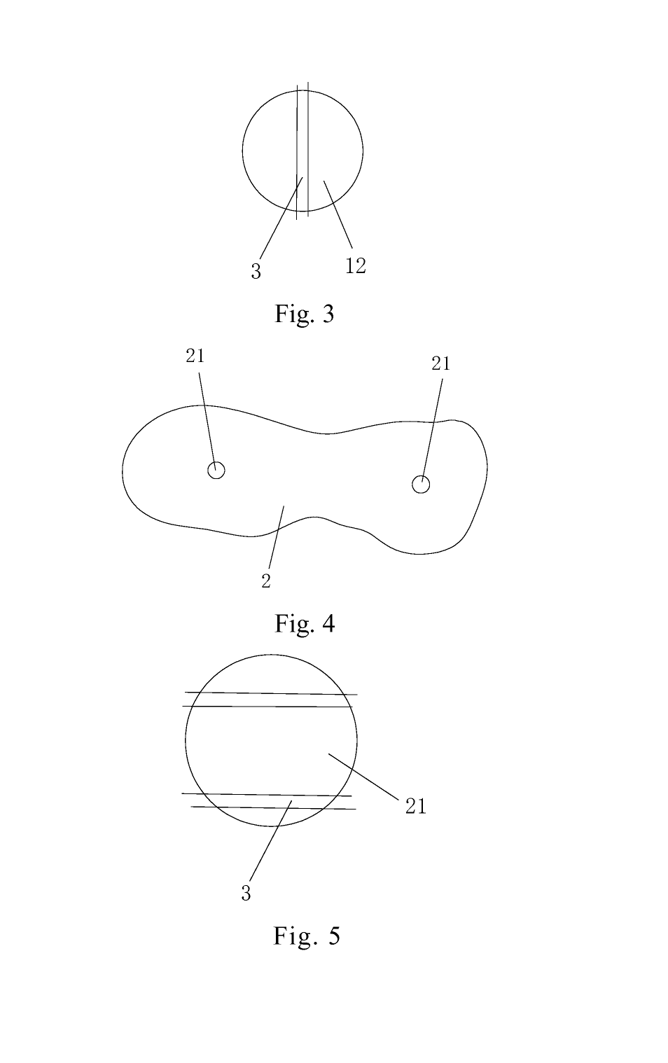

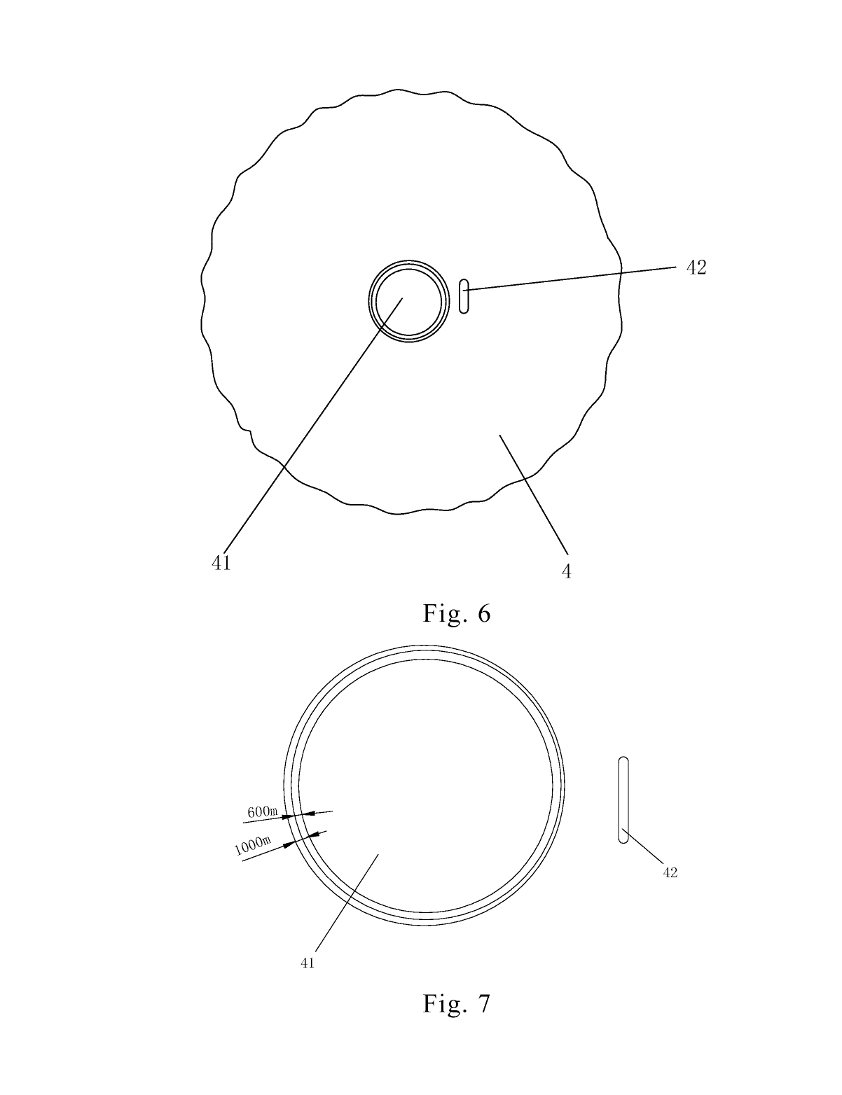

FIG. 1 is a sketch view of an approximately circular typhoon cloud layer 1 according to a preferred embodiment 1 of the present invention; wherein there are one larger central position 11 and two smaller non-central positions 12. FIG. 2 is an enlarged view of the central position 11 of the FIG. 1. FIG. 3 is an enlarged view of the non-central positions of the FIG. 1. FIG. 4 is a sketch view of a long tornado or rainstorm cloud layer 2 according to a preferred embodiment 2 of the present invention; wherein there are two hottest positions 21. FIG. 5 is an enlarged view of the hottest positions 21 of the FIG. 4. Furthermore, referring to FIGS. 2, 3 and 5, the central position 11, the non-central positions 12 and the hottest positions 21 are all artificial rain areas, wherein there are artificial rain bands 3 with different directions, sizes and lengths in the artificial rain areas.

The nature acts in a circular mode. One purpose of the long artificial rain bands 3 is to prevent hot clouds and hot air below from rushing upwards in a rotation mode, so as to avoid high-speed rotation updraft or turbulence. The directions, the sizes and the lengths of the artificial rain bands 3 are determined according to theories, and actual lengths or sizes are adjustable according to a size of the cloud layer. If the artificial rain bands 3 are close to an airport or flight paths, the directions and positions of the artificial rain bands 3 are changeable, in such a manner that the artificial rain bands 3 are at least 5 km from the airport or the flight paths.

The artificial rain band 3 of the typhoon cloud layer 1 has a south-north direction because airflow or cloud layers of big oceans generally move by suction of west hot air. Because a speed of moving to the west is fast, a large area of clouds at the artificial rain band 3 with the south-north direction will move or spread to the west after being cooled, for cooling the large area of clouds into rain. Of course, cold clouds within the artificial rain bands 3 will also spread all around.

The artificial rain bands 3 are arranged at two sides of a center point of the central position 11 because of the above “cloud layer internal convection theory”. The center point of the central position 11 is hottest, so the clouds cooled by the artificial rain will be sucked by the center point more quickly, so as to more rapidly cool hot clouds at the center point.

In strong typhoon seasons, there are many cloud layers gathered above oceans. Before a cloud layer which is hottest due to being largest gradually develops and becomes a “main cloud layer” of a “tropical depression” or “typhoon”, the cloud layer will strongly suck clouds nearby for being larger, denser and hotter, and will be transformed from a non-circular shape at a beginning of gathering into a circular shape within a low-pressure circle due to the above “slow rotation” effect and compression caused by the “cloud internal convention”, wherein a speed of the “slow rotation” has will be gradually and slowly increased.

The above typhoon cloud layer will continuously become larger, thicker, denser and hotter, and a temperature as well as a humidity of the air below will also be gradually increased. Although the formation of the typhoon is slower than the formation of the tornado, the artificial rain is able to be provided at such stage. After the above huge cloud layer is provided with the artificial rain, the cloud layer will also be suck by a land for bring a lot of rain to the land.

The lengths and sizes of the artificial rain bands 3 are adjustable according to a size of the cloud layer. For example, two artificial rain bands 3 with a length of 25 km and a width of 1.2 km are arranged at the central position 11 of the typhoon cloud layer 1 with a diameter of about 700 kilometers. If the diameter of the cloud layer is about one thousand kilometers, the length of the artificial rain bands 3 may be increased to 30 km and the width may be increased to 1.5 km. If the cloud layer is even larger, two artificial rain bands 3 with a length of 8 km and a width of 0.5 km are respectively arranged at two smaller non-central positions 12 which are 30 km east from a boundary of the central position 11, then the artificial rain agent is simply dropped above the artificial rain bands 3. Dropping amounts and periods depend on actual situations.

In summers, due to land cloud layers are hotter than ocean cloud layers and land geographical environments differ a lot, land weathers also differ a lot, wherein land airflow is unstable and fast, which is easy to generate the cloud convection, so the gathering processes of the tornado or storm cloud layers are fast and fierce.

The tornado or rainstorm cloud layer 2 has a plurality of the hottest positions 21. Each of the hottest positions 21 is able to generate the “cloud layer internal convection” for being denser and hotter, until a temperature thereof is raised to a limit and thus generates a tornado or exceptionally strong thunderstorm [wherein cloud layers generating the tornado are closer to a ground]. In fact, on above-mentioned large plains, a huge cloud layer may generate a plurality of tornados.

Since the tornado or exceptionally strong thunderstorm are able to be quickly formed 15-30 min after the cloud layer convection and the cloud layer convection may happen at any time, the simple artificial rain should be provided to the hottest position 21 of the largest and hottest cloud layer 2 best before the cloud convection of the two cloud layers, in such a manner that the cloud layer 2 is cooled and is incapable of sucking the other cloud layer. Providing the artificial rain in advance is able to cool the cloud layer, the air below the cloud layer and above the ground in advance, while cooling the ground is also able to cool the cloud layer. Two artificial rain bands 3 with a length of 15 km and a width of 0.8 km may be arranged at the hottest positions 21 in the cloud layer, and then the artificial rain agent is simply dropped above the artificial rain bands 3.

Because flow directions of the land cloud layers are uncertain, the directions of the artificial rain bands depend on the flow directions of the cloud layers. For example, if the cloud layer flows to the south or north, the artificial rain band 3 must have an east-west direction. If the cloud layer flows to other directions, the artificial rain band 3 must have a south-north direction or other directions. Methods of the artificial rain comprises dropping or spraying the artificial rain agent by an aircraft, launching an artificial rain bullet to the cloud layer by a rocket, and shining with a laser.

An object of the artificial rain bands 3 at the central position 11, the non-central positions 12 and the hottest positions 21 is to provide an artificial discharging channel in the cloud layer, so as to release a large amount of hot air under cloud layer and cool the cloud layer, which will also decrease the cloud amount, the cloud density, the cloud temperature and so on. The action eliminates natural formation conditions of typhoons, tornados, thunderstorms, strong cloud layer convection, etc., and also drives cooled cloud layers to neighboring hot or drought areas.

Method for Weakening or Destroying Already Formed Typhoons According to the Present Invention

The present invention is mainly to prevent formation of typhoons or hurricanes. If the formation if not prevented by the above simple artificial rain method, it is possible to weaken or destroy the typhoon of the hurricane with a following method. The present invention has figured out exact causes and running processes of typhoons, so it is considered to be possible in theory to weakening or destroying already formed typhoons, change a typhoon moving direction or avoid typhoon landing. However, such method costs a lot, so it is necessary to firstly determine whether the typhoon is going to attack an important area such as an important city, an area with important sports, political or military activities, etc.

In the past, there was an expert in a big country who suggested destroying a hurricane wind eye with a nuclear bomb. Of course, a nuclear bomb will bring serious side effects. The country also tried dropping a lot of been used only to cast a lot of silver iodide (an artificial rain agent) only beside wind eye walls. However, it was different from the artificial rain position and method of the present invention. The above silver iodide action proves that weakening already formed typhoons are necessary and has economic benefits.

FIG. 6 is a sketch view of a typhoon according to a preferred embodiment 3 of the present invention, and FIG. 7 is a partial enlarged view of the FIG. 6. Referring to FIGS. 6 and 7, a cloud layer of a formed typhoon rotates rapidly and is circular, and a wind eye 41 is formed.

As explained above, there is rapid rotation updraft beside a wall of the wind eye 41, there are also falling scattered clouds or heavy airflow, which together with factors such as a laterally moving hurricane will affect an artificial rain effect and/or threaten the plane for dropping the artificial rain agent. Therefore, a position beside the wind eye wall is not suitable and effective for being a long-term position where a lot of silver iodide is dropped.

It is said that after dropping a lot of silver iodide, a hurricane power was indeed decreased slightly. However, the hurricane suddenly turned to an unprotected area and caused more losses. Therefore, the method of dropping silver iodide and an action of weakening hurricane are permanently stopped.

The actual reason of suddenly turning of the typhoon is mentioned above, and it is very likely a coincidence that the above hurricane suddenly changed a direction. In theory and fact, typhoon itself may change a direction at any time. Typhoon just moves following a low-temperature with a diameter of thousands kilometers, so dropping a lot of silver iodide at the wind eye with a diameter of 40 km should have nothing to do with the sudden change of direction.

Some typhoons are naturally weakened. A method for weakening or destroying an already formed typhoon comprises steps of firstly tracking and monitoring a route the typhoon with a satellite, analyzing whether environments in the route will naturally weaken the typhoon or not. The method is adaptable for weakening or destroying the typhoon if the typhoon will not be naturally weakened and move towards an important area,

A size of the naturally formed wind eye 41 is important to the typhoon. The rotation effect, centrifugal force or centripetal force caused by a huge amount of high-pressure hot air which rapidly rotates and rise through the wind eye will pressure against the wind eye wall and clouds beside the wind eye wall for keeping the wind eye circular. The powerful natural force is necessary for typhoons, because if there is no airflow which rapidly rotates and rises, there will be no strong force which keeps the naturally formed width of the wind eye 41 and the extremely circular shape.

While the high-speed rotating updraft passes though the wind eye and thus generates a stable “centrifugal force” or “centripetal force”, the dense clouds beside the wind eye wall surely bears a strong “outwards pushing force and traction force”, in such a manner that cloud layers around the wind eye 41 become densest or strongest cloud layers.

In theory, the naturally formed pushing force or traction force is necessary and important to the typhoon. If a density, temperature and measurement of clouds at such position are rapidly or suddenly decreased by the artificial rain, the outwards pushing force must be easy to push the clouds whose density has been decreased outwards and thus expand the wind eye. However, artificially expanding or deforming the wind eye is extremely unfavorable for typhoon surviving. For example, when a typhoon wind eye suddenly crashes with a highest mountain of <Taiwan> and is deformed, strength of the typhoon will be reduced.

The thicker and denser the typhoon cloud layer is, the larger the diameter of the wind eye 41 will be. In addition, the typhoon itself rains. If a rain amount thereof needs to be increased and a temperature needs to be decreased above a sea, it is necessary to drop strong artificial rain agent at a proper artificial rain position for a relatively long time.

According to the artificial rain method, best during a low temperature period of the typhoon cloud layer, in a 400-meter space which is 600-1000 m away from the wind eye wall, a lot of the artificial rain agent is sprayed around the wind eye 41 in a continuous and concentrated from for increasing the rain amount, as shown in FIG. 6-7, until the clouds of the wind eye wall are gradually pushed outwards by the above pushing force, so as to expand a total diameter of the wind eye by 0.5-4 km, preferably 2 km.

The artificial rain is provided at the 400-meter space which is 600-1000 m away from the wind eye wall because during the clouds of the wind eye wall are pushed for slowly expanding the wind eye, the artificial still must be remained at a position 600 m away from the wind eye wall, until the total diameter of the wind eye is expanded by 2 km. If necessary, the total diameter is able to be expanded by more than 2 km.

A reason for expanding for 2 km is as follows: for example, the diameter of the wind eye 41 is 40 kilometers; if artificially expanding [pushing] by 1 km from the eye wall, i.e. 1 km at two sides, the total diameter of the wind eye is expanded to 42 km. Increasing the total diameter by 2 km does not mean only increasing the wind eye by 1/20, because an outer 2 km space is larger.

If the [brick neck] at the wind eye is artificially expanded, a wind speed of the rotating updraft will be lowered. A principle thereof is equivalent to replacing a tiny gas outlet with a large gas outlet, which will instantly lower an outlet speed. Decrease of the wind speed means weakening the centrifugal or centripetal force, in such a manner that the wind eye is no longer tiny and extremely circular, wherein the wind eye will then gradually deform or disappear.

The above-described artificial rain method and position not only expand the wind eye, but also comprises following important effects. When the rain amount at the above position is increased, large raindrops which are cold due to being denser will rapidly cool the extremely dense cloud layer at the position and cause compression, which decreases the density and cloud amount of the cloud layer at the position. Therefore, most hot air below the cloud layer will rise (be release) through the position in advance, so as to avoid that all the hot air is concentrated at the wind eye for rising. That is to say, an amount of air rising through the wind eye is reduced, and a speed of the rotation airflow rising through the wind eye is lowered, thereby destroying a natural structure of the wind eye. The artificial rain position of the above country had no such important effect.

Since clouds are soft substance and have a huge amount, and are not solid substance which is able to be instantly damaged, and because the typhoon is slowly enhanced and weakened as well as other faction, a long-term artificial rain is necessary for expanding the wind eye 41 (generally about 1-2 h or more). In theory, the above actions are effective, safe and simple to operate. Besides, a strong large laser is applicable to remove the clouds at the above position more quickly. An expanded width of the wind eye does not need to be extremely accurate, which is able to be measured by conventional advanced laser measurement techniques. The expanded of the wind eye 41 or a period of the artificial rain are adjustable according to actual conditions.

The artificial rain position and method is able to more directly, concentrately and completely reduce the temperature and density of the cloud layer beside the wind eye wall and decreases the cloud amount beside the wind eye wall as well as the air amount rising from the wind eye, and is also able to lower a speed of the airflow which rotates and rises. Therefore, the wind eye is able to be artificially expanded. When losing the natural formed centrifugal force, the wind eye will deform and disappear, which transforms the typhoon into a storm without wind eye, equaling weakening and destroying the already formed typhoon.

The above artificial rain method and position are enough for weakening a common typhoon. A cloud layer of a super typhoon is extremely large and thick, hot air below is also more and hotter (in fact, some super typhoons will occasionally have double wind eyes for more rapidly releasing more and hotter air below the cloud layer). To weaken the super typhoon, an artificial rain band [gas discharging channel] 42 with a length of 10-15 km and a width of 500 m is additionally arranged 5 km east to a wind eye wall, as shown in FIG. 7; and enhanced artificial rain agent is dropped above the artificial rain band 42 in a lasting and concentrated manner, so as to release a huge amount of the hot air. Besides, a strong laser is applicable to eliminate “discharging channel” clouds, in such a manner that cloud below and part hot air nearby rise through the “discharging channel” in advance.

Method for Changing a Typhoon Route or Preventing a Typhoon from Landing According to the Present Invention

Typhoon is a cloud layer or air moving forwards, which will only be sucked by a near front with a relatively high above-below average temperature or a relatively low atmospheric pressure, and thus move forwards without a certain direction step by step. The typhoon never likes a car which is able to freely turn a ninety-degree corner, pause or return. Due to the air of the sea where the typhoon passes is slightly cooled by typhoon rain, the typhoon hardly returns. However, very few typhoons will turn a corner or return after a short stay, because a sea area (such as the Gulf of Mexico or South China Sea) where the typhoon was at that time was relatively hot, while a continent in a front is lower in temperature and higher in pressure than the sea area. Another reason for turning a corner or returning is that the typhoon is sucked by a strong low-pressure circle in a short distance, for example, double typhoons.

If an atmospheric pressure of the near continent in front of the typhoon is increased due to heavy rain, or the above-below average temperature is dramatically decreased because of inflow cold winds, the typhoon will return or be unable to land. In fact, when cold air suddenly appears at the continent in front of the typhoon, the typhoon is not able to land.

If the typhoon is moving towards areas where important sports, political or military activities happen, the typhoon is necessary to be changed in route or prevent from landing. Based on the above explanation, in theory and technology, if a large dense cloud layer is gathered within the above important areas, the artificial rain method is applicable to cause rain in such areas, so as to lower a large-range above-below average temperature of the areas in advance for changing the route.

Based on a moving speed of 12 km/h of the typhoon, in theory, a time for providing the artificial rain in advance is about 30 h before the low-pressure circle of the typhoon arrives at the area. Since the moving speed of the typhoon will change at any time, the time depends on the moving speed of the typhoon at that time.

Method for Preventing Heavy Rain, Strong Thunder and Strong Wind Shear and Serious Air Pollution According to the Present Invention

The dense cloud layer will form the “strong greenhouse effect” and the active low atmospheric pressure, which is easy to cause strong cloud layer convection and strong cloud layer internal convection. The high temperature and the low atmospheric pressure will absorb clouds and polluted air nearby, in such a manner that the cloud layer becomes thicker and denser. As a result, a localized strong thunderstorm which has extremely large rain drops and is highly concentrated. The dense cloud layer also prevents the polluted air from normally rising.

Based on the above explanation of the sun which arrives at and returns from the tropic of cancer and other explanations, in the northern hemisphere, areas to the south of the tropic of cancer is relatively hot during May to June and thus gathers a lot of clouds, leading to a lot of strong thunderstorms. During July to September, rainstorm areas are often distributed at and to the north of the tropic of cancer with high latitudes. Clouds are easy to be gathered above high mountains, hot cities, etc., which are easy to be a central position or a hottest position of a cloud layer. Therefore, the cloud layer is thicker, denser and hotter, so it is easy to cause exceptionally strong thunderstorms.

To avoid the above situations, it is necessary to find out the hottest position of the thunderstorm cloud layer before large-range extremely strong rainfall is automatically formed due to the cloud layer convection and the cloud layer internal convection, and then to provide the artificial rain at one of the hottest positions with the artificial rain method, in such a manner that the thick dense cloud layer rains in orders of sequences, areas and periods, so as to avoid the entire huge cloud layer is gathered to be denser, and thus automatically forms the exceptionally strong thunderstorms and falls at the same time.

The so-called “after rain the sky looks blue” is caused by raining which not only spreads and eliminates the hot clouds as well as cools the air, but also increases the atmospheric pressure and removes the polluted air. Since the cloud layer temperature will be lowered at evening, the cloud layer is easy to be cooled into rain. Therefore, the artificial rain may be provided at night, which is also able to avoid affecting normal lives of the people.

Some areas on the Earth suffer from the above weather disasters every year, causing hurt and death of countless lives and property losses of dozens of billions or even hundreds of billions, which also seriously affects the economy. Artificial releasing the hot air rising pressure caused by the “strong greenhouse effect” in advance is surely superior to naturally releasing which leads to serious disasters. With modern technologies and production capacity, it is not difficult or expensive to produce some eco-friendly artificial rain agent or other chemical agents in a mass and cheap manner, as well as modifying some aircrafts for spraying the artificial rain agent. A cost thereof is hundreds or thousands times less than the economic and life losses caused by the weather disasters, while avoiding life losses are most important.

1-8. (canceled)

9: A method for preventing serious weather disasters, comprising steps of:
(A) finding an area, where thick cloud layers are gathered, by a conventional meteorological technology;
(B) defining an artificial rain position with a highest density, thickness or temperature in the cloud layers; and
(C) setting one or more artificial rain bands with a strip shape at the artificial rain position, and providing artificial rain, in such a manner that clouds to which the artificial rain is provided are cooled to rain; temperatures, densities and measurements of the cloud layers are lowered; and hot air below the cloud layers is released; wherein the clouds after being cooled flow to and cool hot clouds nearby, so as to rain one after another, thus eliminating natural conditions for forming the serious weather disasters.

10: The method, as recited in claim 9, wherein the artificial rain bands are set at a position for rapidly cooling hot cloud layers.

11: The method, as recited in claim 9, wherein the artificial rain position is set at a center or a hottest position of the cloud layers.

12: The method, as recited in claim 9, wherein the artificial rain bands are set at two sides of a center of the cloud layers.

13: The method, as recited in claim 11, wherein the serious weather disasters are typhoons, and a center point of the cloud layers has a diameter of 20-40 km.

14: The method, as recited in claim 12, wherein the serious weather disasters are typhoons, and a center point of the cloud layers has a diameter of 20-40 km.

15: The method, as recited in claim 11, wherein the serious weather disasters are tornados or rainstorms, and a hottest position of the cloud layers has a diameter of 10-30 km.

16: The method, as recited in claim 12, wherein the serious weather disasters are tornados or rainstorms, and a hottest position of the cloud layers has a diameter of 10-30 km.

17: The method, as recited in claim 9, wherein a method of providing the artificial rain comprises a step of: dropping an artificial rain agent at an up-middle portion or a top portion of the artificial rain band of the cloud layers for providing the artificial rain.

18: The method, as recited in claim 9, wherein a method of providing the artificial rain comprises a step of: above the cloud layers which is 600-1000 m away from a wind eye wall, spraying an artificial rain agent around a wind eye, until the wind eye is artificially expanded by 0.5-4 km.
